(19) United States
(12) Patent Application Publication
(10) Pub. No.: US 2022/0152506 A1
(43) Pub. Date: May 19, 2022

(54) RECORDING MEDIUM, GAME APPARATUS, AND CONTROL METHOD FOR GAME APPARATUS

(71) Applicant: Konami Digital Entertainment Co., Ltd, Tokyo (JP)

(72) Inventors: Shigeru CHIBA, Tokyo (JP); Kai INOUE, Tokyo (JP); Junki HIRAI, Tokyo (JP); Akira SAKAI, Tokyo (JP)

(73) Assignee: Konami Digital Entertainment Co., Ltd., Tokyo (JP)

(21) Appl. No.: 17/592,681

(22) Filed: Feb. 4, 2022

Related U.S. Application Data
(63) Continuation of application No. PCT/JP2020/028387, filed on Jul. 22, 2020.

(30) Foreign Application Priority Data
Aug. 6, 2019 (JP) 2019-144464

(51) Int. Cl. A63F 13/56

(52) U.S. Cl. CPC A63F 13/56

(57) ABSTRACT

A non-transitory computer readable recording medium having instructions stored therein that cause at least one processor of a game apparatus to: progress a video game; initiate a period for supporting to receive support for a specific object of the video game, when a game state of the video game that is progressed based on a user input corresponds to a specific game state; acquire support information from a terminal apparatus communicably connectable with the game apparatus in the period for supporting, the support information being based on a specific input made to the terminal apparatus; and change an ability associated with the specific object based on the support information.

### CROSS REFERENCE TO RELATED APPLICATIONS

This Application is a Continuation Application of PCT Application No. PCT/JP2020/028387, filed on Jul. 22, 2020, and is based on and claims priority from Japanese Patent Application No. 2019-144464 filed on Aug. 6, 2019, the entire contents of each of which are incorporated herein by reference.

### BACKGROUND

### Field of the Invention

The present disclosure relates to recording mediums, to game apparatuses, and to control methods for game apparatuses.

### Description of Related Art

In a communication game system, a video game has been proposed in which an ability of a player character changes in response to the number of spectators of the video game (e.g., Japanese Patent Application Laid-Open No. 2004-167172). Furthermore, in a competitive video game, a system has been proposed to increase an ability of a player character by cheering spectators of the competitive video game.

In a system in which an ability of a player character is increased by cheering by spectators, it is determined in advance for whom and when the spectators cheer. As a result, the spectators may be less aware of participation in a competitive video game, and excitement in the video game may be lacking.

### SUMMARY

The present disclosure has been made in view of the situations described above, and it has an object to provide a technique for maintaining spectator's awareness of participation in a competitive video game.

To achieve the stated object, a recording medium according one aspect is a non-transitory computer readable recording medium having instructions stored therein that cause at least one processor of a game apparatus to: progress a video game; initiate a period for supporting to receive support for a specific object of the video game, when a game state of the video game that is progressed based on a user input corresponds to a specific game state; acquire support information from a terminal apparatus communicably connectable with the game apparatus in the period for supporting, the support information being based on a specific input made to the terminal apparatus; and change an ability associated with the specific object based on the support information.

A game apparatus according one aspect includes at least one memory storing a program; and at least one processor that implements the program to: progress a video game; initiate a period for supporting to receive support for a specific object of the video game, when a game state of the video game that is progressed based on a user input corresponds to a specific game state; acquire support information from a terminal apparatus communicably connectable with the game apparatus in the period for supporting, the support information being based on a specific input made to the terminal apparatus; and change an ability associated with the specific object based on the support information.

A computer-implemented control method for a game apparatus according to one aspect includes: progressing a video game; initiating a period for supporting to receive support for a specific object of the video game, when a game state of the video game that is progressed based on a user input corresponds to a specific game state; acquiring support information from a terminal apparatus communicably connectable with the game apparatus in the period for supporting, the support information being based on a specific input made to the terminal apparatus; and changing an ability associated with the specific object based on the support information.

### BRIEF DESCRIPTION OF THE DRAWINGS

FIG. 1 is a diagram showing an overview of a game system according to the embodiment.

FIG. 2 is a diagram showing an overview of a video game movie generated by each game terminal shown in FIG. 1.

FIG. 3 is a functional block diagram of an example configuration of each game terminal shown in FIG. 1.

FIG. 4 is an example of a hardware configuration of each game terminal shown in FIG. 3.

FIG. 5 is a functional block diagram showing an example configuration of a distribution server shown in FIG. 1.

FIG. 6 is an example of a hardware configuration of the distribution server shown in FIG. 5.

FIG. 7 is an example of a functional block diagram of a game management server shown in FIG. 1.

FIG. 8 is an example of a hardware configuration of the game management server shown in FIG. 7.

FIG. 9 is a functional block diagram showing an example of the configuration of each cheer terminal shown in FIG. 1.

FIG. 10 is an example of hardware configuration of each cheer terminal shown in FIG. 9.

FIG. 11 is a functional block diagram showing an example of the configuration of each viewer terminal shown in FIG. 1.

FIG. 12 shows an example of the hardware configuration of each viewer terminal shown in FIG. 11.

FIG. 13 is an example of a data structure of a game management table.

FIG. 14 is a diagram showing an overview of procedures for each game terminal shown in FIG. 3.

FIG. 15 is a diagram following FIG. 14 which is the overview of procedures for each game terminal.

FIG. 16 is a sequence chart of example procedures for the game system shown in FIG. 1.

FIG. 17 is a flowchart showing an example of procedures for each game terminal shown in FIG. 3.

FIG. 18 is a diagram showing an overview of procedures for each game terminal according to modification 1.

FIG. 19 is a diagram showing an overview of procedures for each game terminal according to modification 2.

FIG. 20 is an example display image shown on a display of each cheer terminal according to modification 5.

FIG. 21A is a diagram showing an overview of a game system according to modification 8.

FIG. 21B is a functional block diagram showing an example configuration of a game management server shown in FIG. 21A.

### DESCRIPTION OF THE EMBODIMENT

Hereinafter, modes for carrying out the present disclosure will be described with reference to the drawings. In each diagram, the dimensions and scale of each element are appropriately different from actual ones. Embodiment described below is preferable specific examples of the present disclosure. Accordingly, various technically preferable limitations are applied. However, the scope of the present disclosure is not limited to these modes unless there is a specific description limiting the present disclosure.

### 1. Embodiment

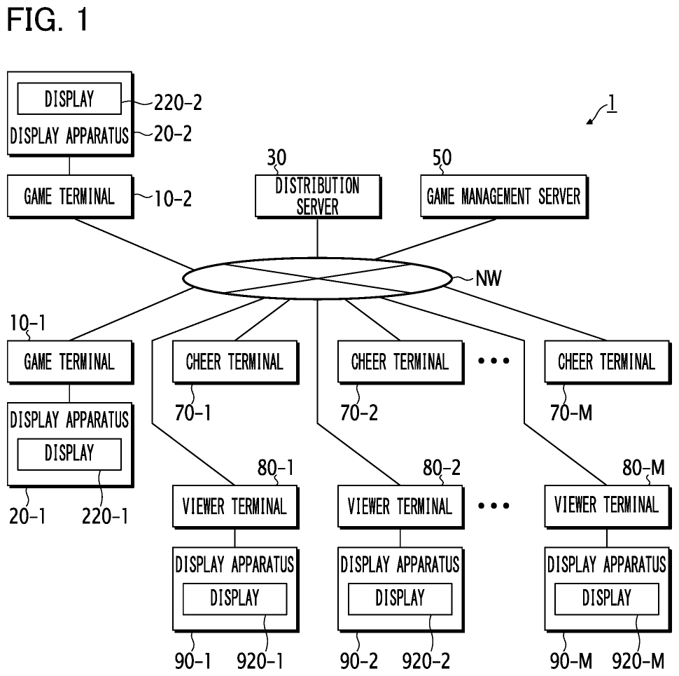

First, description will be given of an example outline of a game system 1 according to an embodiment with reference with FIG. 1.

FIG. 1 is a diagram showing an overview of the game system 1 according to the embodiment.

The game system 1 shown in FIG. 1 includes two game terminals 10 (10-1 and 10-2) that are executable for a given video game, two display apparatuses 20 (20-1 and 20-2) that corresponds to the respective two game terminals 10, a distribution server 30, and a game management server 50. Furthermore, the game system 1 includes a plurality of M cheer terminals 70 (70-1 to 70-M), a plurality of M viewer terminals 80 (80-1 to 80-M), and a plurality of M display apparatus 90 (90-1 to 90-1) for the respective M viewer terminals 80. The M is a natural number of one or more. In one example, each of the game terminals 10, the distribution server 30, the game management server 50, each of the cheer terminals 70, and each of the viewer terminals 80 are connected communicably to one another via a network NW. A game terminal 10 is an example of a “game apparatus.” In the following description, the m-th cheer terminal 70 of the plurality of M cheer terminals 70-1 to 70-M is occasionally referred to as a cheer terminal 70-m. The in is a natural number satisfying 1≤in≤M. Similarly, the m-th viewer terminal 80 of the M viewer terminals 80-1 to 80-M is occasionally referred to as a viewer terminal 80-m. The m-th display apparatus of the display apparatus 90-1 to 90-M is occasionally referred to as a display apparatus 90-m.

In this embodiment, an example will be given in which each game terminal 10 is for home use. However, a freely selected information processing apparatus is used for each game terminal 10. Examples of each game terminal 10 include a business-use game device installed in a store or an amusement facility, a mobile device such as a cellar phone or a smart phone, and a stationary information device such as a personal computer.

In one example, the game terminal 10-1 sends, to the game terminal 10-2 via the game management server 50, information on the given video game being implemented on the game terminal 10-1. The game terminal 10-2 sends, to the game terminal 10-1 via the game management server 50, information on the given video game being executed by the game terminal 10-2. This allows the information on the given video game being executed on each game terminal 10 to be shared among the game terminals 10-1 and 10-2. Accordingly, a user controlling the game terminal 10-1 and another user controlling the game terminal 10-2 are able to cooperate with each other in the given video game to complete a mission, or are able to play against each other in the given video game. The game terminals 10 may communicate with one another without going through the game management server 50. In this embodiment, an example will be given in which the user of the game terminal 10-1 and the other user of the game terminal 10-2 play against each other in a baseball video game (an example of a “video game”).

The game terminal 10-1 is communicable with the display apparatus 20-1 corresponding thereto. The game terminal 10-2 is communicable with the display apparatus 20-2 corresponding thereto. Each game terminal 10 shows, on a display 220 (an example of a “display”) included in the display apparatus 20 corresponding to the game terminal 10, a video game movie related to a baseball video game being executed by the game terminal 10. Examples of the display apparatus 20 include a liquid crystal display, a television receiver, and a touch panel display. The display apparatus 20 may be included in the game terminal 10. The number of game terminals 10 included in the game system 1 is not limited to two, and it may be one, three, or more.

In one example, each game terminal 10 supplies the distribution server 30 with a video game movie related to the baseball video game being executed on the game terminal 10. In this embodiment, an example will be given in which two video game movies are the same between the display 220-1 corresponding to the game terminal 10-1 and the display 220-2 corresponding to the game terminal 10-2. In one example, either the game terminal 10-1 or 10-2 supplies, to the distribution server 30, the same video game movie to be shown on a corresponding display 220. In this embodiment, an example will be given in which a video game movie to be supplied to the distribution server 30 is identical to that to be shown on the display 220, but the present disclosure is not limited to such a case. In one example, the video game movie to be supplied to the distribution server 30 may have a lower resolution than the video game movie to be shown on the display 220.

In response to receiving a supply of a video game movie from a game terminal 10 and receiving from a viewer terminal 80-m a request for distribution of the video game, the distribution server 30 distributes, to the viewer terminal 80-m, the video game movie supplied from the game terminal 10.

In response to receiving a video game movie supplied from the distribution server 30, the viewer terminal 80-m shows the video game movie on the display 920-m included in the display apparatus 90-m corresponding to the viewer terminal 80-m. A freely selected information processing apparatus connectable with the Internet may be used for the viewer terminal 80-m, examples of which include a smartphone, a cellar phone, and a personal computer. Examples of the display apparatus 90-m include a liquid crystal display, a television receiver, and a touch panel display. The display apparatus 90-m may be included in the viewer terminal 80-m.

In a period for cheering to receive a cheer for a specific object of the baseball video game, a cheer terminal 70-m receives a cheering input (an example of a “specific input”) for the specific object, and sends cheer information based on the received input for cheering to the game management server 50. An examples of the specific object is an object controlled by the user of the game terminal 10 playing the baseball video game, specifically, a baseball character, and a baseball team.

In the following description, either of the users of the game terminal 10-1 or 10-2 is occasionally referred to as a player, and the other is occasionally referred to as an opposing player. A user of a cheer terminal 70-m is occasionally referred to a spectator. In this embodiment, an example will be given in which the user of the cheer terminal 70-m is identical to a user of a viewer terminal 80-m. In one example, the spectator of the cheer terminal 70-m watches the video game movie shown on the display 920-m included in the display apparatus 90-m corresponding to the viewer terminal 80-m. The spectator makes a cheering input to the cheer terminal 70-m in the period for cheering, for example. A freely selected information processing apparatus connectable with the Internet may be used for the cheer terminal 70-m, examples of which include a smartphone, cellar phone, and a personal computer. The cheer terminal 70 may have a function of showing the video game movie. In other words, the cheer terminal 70-m and the viewer terminal 80-m may be a single same terminal apparatus.

In one example, the game management server 50 controls the communication between the game terminals 10, as described above. Furthermore, the game management server 50 controls the communication between the game terminals 10 and the cheer terminals 70. In one example, the game management server 50 sends cheer information received from the cheer terminal 70-m to each game terminal 10. In other words, in the example shown in FIG. 1, each cheer terminal 70 is connected to each game terminal 10 via the network NW and the game management server 50.

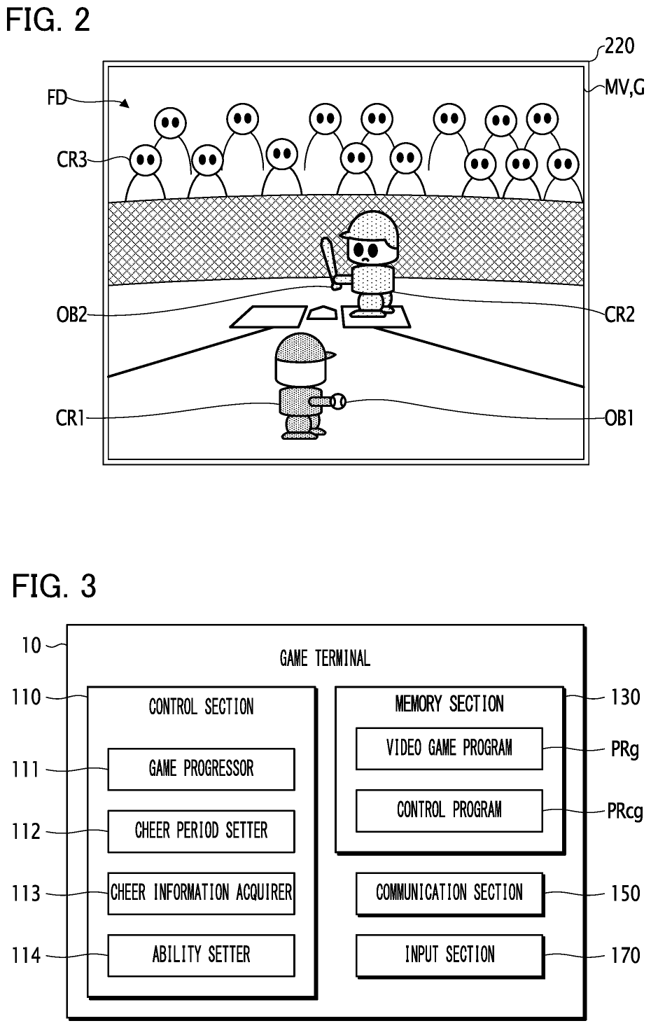

Next, description will be given of an overview of a video game movie generated by each game terminal 10 with reference to FIG. 2.

FIG. 2 is a diagram showing an overview of a video game movie MV generated by each game terminal 10 shown in FIG. 1.

The video game movie MV according to this embodiment describes progress of the baseball video game in a virtual space FD, such as a virtual baseball field. The progress of how the baseball video game is going in the virtual space FD is an example of a “game state of the video game.” The “game state of the video game” may be a state of the virtual space FD of the video game, examples of which include a part or all of a game state related to game elements in the virtual space FD, and a part or all of a game state related to a sound in the virtual space FD. Alternatively, the “state of the virtual space FD” may be a part or all of a game state including the following: (i) a game state related to game elements in the virtual space FD; and (ii) a game state related to a sound in the virtual space FD.

A still image representative of a state of the virtual space FD may be, as a game image G, shown on the display 220, and the game image G shown on the display 220 may be updated for each unit period of time. As a result, a video game movie MV is shown on the display 220. The video game movie MV describes a state of the virtual space FD, which changes in accordance with a progress of the baseball video game.

In the example shown in FIG. 2, the video game movie MV describes that, in the virtual space FD, a pitcher character CR1 is throwing a ball object OB1, and a batter character CR2 is hitting the ball object OB1 thrown by the pitcher character CR1 with a baseball bat object OB2. In an example of the video game movie MV, spectator characters CR3 watch a baseball game in the virtual space FD. The video game movie MV according to this embodiment may include an image representative of an amount of cheering based on the cheer information.

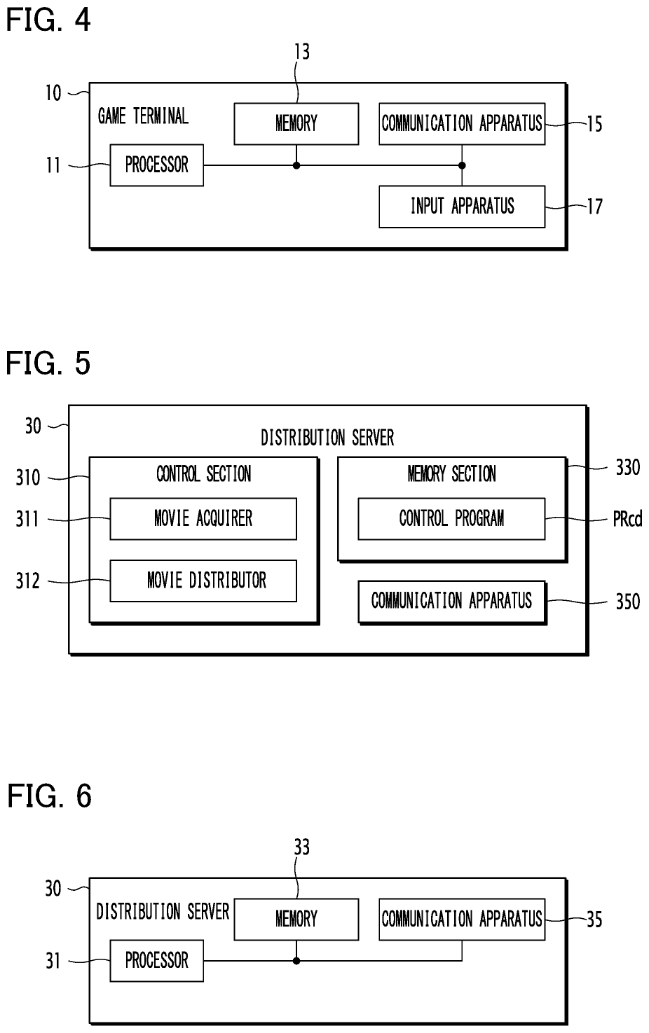

Next, referring to FIGS. 3 to 12, description will be given of functions of each game terminal 10, the distribution server 30, the game management server 50, each cheer terminal 70, and each viewer terminal 80. First, the configuration of each game terminal 10 will be described with reference to FIGS. 3 and 4.

FIG. 3 is a functional block diagram of an example configuration of each game terminal 10 shown in FIG. 1. Description will be now given of a configuration, procedures, and other matters of either one of the game terminal 10-1 or 10-2. Unless otherwise noted, a “user” and a “user of a game terminal 10” are intended to be a user of a game terminal 10 on which attention is focused.

The game terminal 10 includes: a control section 110; a memory section 130 that stores information, such as a video game program PRg (an example of a “program”) and a control program PRcg; a communication section 150 that communicates with external apparatuses including the distribution server 30 and the game management server 50; and an input section 170 that receives user inputs made to the game terminal 10. In one example, the video game program PRg is an application program for the game terminal 10 to execute the baseball video game. In one example, the control program PRcg is an operation system program for the control section 110 to control each part of the game terminal 10.

The control section 110 controls each part of the game terminal 10. Furthermore, the control section 110 controls progress of the baseball video game executed in the game terminal 10. In one example, the control section 110 includes a game progressor 111 (an example of a “progressor”), a cheer period setter 112 (an example of a “period setter”), a cheer information acquirer 113 (an example of an “acquirer”), and an ability setter 114 (an example of an “ability setter”).

In one example, the game progressor 111 progresses the video game, and shows, on the display 220, a video game movie MV describing a game state of the progressed video game. In one example, the game progressor 111 progresses the video game based on a user input made to the game terminal 10. Thereafter, the game progressor 111 generates progress state information on a game state of the progressed video game. Furthermore, the game progressor 111 generates video game movie information on playback of the video game movie MV based on the generated progress state information. As a result, in one example, the display 220 shows the video game movie MV based on the video game movie information generated by the game progressor 111. In addition, to distribute the video game movie MV, the game progressor 111 sends the video game movie information to the distribution server 30 via the communication section 150. As a result, the video game movie MV based on the video game movie information is distributed to the viewer terminal 80-m, etc.

In response to a change in the state of the virtual space FD under the progress of the video game, the progress state information is used to manage a state of each of various game elements in the virtual space FD, and sounds in the virtual space FD. Specifically, in this embodiment, the progress state information includes some of or all of the following: (i) a sound existing in the virtual space FD; and (ii) the following of each game element in the virtual space FD: a position, a shape, a posture, a direction, a color, a pattern, a speed of movement, and a direction of movement.

Examples of the video game movie information include information on a game image G updated for each unit period of time (real time information on a game image G updated for each unit period of time), information on a set of game images G corresponding one-to-one to multiple unit periods (information on a set of game images G accumulated over unit periods of time). Alternatively, the video game movie information may be obtained by adding information on sound in the virtual space FD to information on a game image G updated for each unit period of time or information on a set of game images G.

The cheer period setter 112 initiates a period for cheering to receive cheer for a specific object of the video game, when the game state of the video game progressed based on the user input made to the game terminal 10 corresponds to the specific game state. Thereafter, the cheer period setter 112 ends the period for cheering after a preset period of time has passed since the start of the period for cheering. It may be unknown whether the specific game state will occur at the start of the video game, examples of which include an event that will occur in accordance with the progress of the video game, specifically, a home run hit by a batter, a base stolen by a runner, and a stealing of a base prevented by a catcher. In the baseball video game, for example, the completion of the third inning does not correspond to the “specific game state,” because it is already known that this state will occur at the beginning of the game. Other specific examples of the specific game state will be described after description of the ability setter 114.

The cheer information acquirer 113 acquires, from a cheer terminal 70 via the game management server 50, cheer information based on the cheering input made to the cheer terminal 70 in the period for cheering. In one example, the cheer information based on the cheering input may represent an amount of cheering obtained by quantifying cheers by the cheering input. The amount of cheering may be an index representative of degree of cheering, or it may be an index to change an ability associated with a specific object.

The ability setter 114 changes the ability associated with the specific object, based on the cheer information obtained by the cheer information acquirer 113.

Examples of the “ability associated with the specific object” include the following: (i) an ability defined by a parameter associated with the specific object; (ii) an ability for the specific object to produce an advantageous effect in the video game; (iii) an athletic ability of the specific object; (iv) an intellectual ability of the specific object; (v) an ability related to a vitality of the specific object; and (vi) if the specific object is a team, a coordination and tactical understanding of the players on the team.

The “ability associated with the specific object” may change linearly or incrementally in response to the amount of cheering based on the cheer information. Alternatively, if there is a plurality of abilities, each of which is associated with the specific object, the number of abilities that change based on the cheer information may increase in response to the amount of cheering based on the cheer information.

An example will be given in which the specific object is a relief, and the reliefs abilities are a controlling, a speed of the ball, and a left-handed batter, all of which are associated with the relief. In such an example, the abilities of the controlling, the speed of the ball, and the anti-left-handed batter may increase in this order in response to an increase in the amount of cheering based on the cheer information.

Alternatively, an example will be given in which the specific object is a batter, and the batter's abilities are smash factor and a flight distance of the ball associated with the batter. In such an example, the abilities of the smash factor and the flight distance may increase in this order in response to an increase in the amount of cheering based on the cheer information.

In the abilities associated with the specific object, an ability that changes based on the cheer information, may the same type of character, or it may differ for each character, or it may be freely selectable by the user of the game terminal 10. The effects (result of the amount of change in ability) based on the cheer information may be maintained until the end of the baseball video game, or they may be deleted at a preset timing (e.g., at the end of an inning).

Here, description will be given of a specific game state that leads to the initiation of the period for cheering in the baseball video game.

As described above, it may be unknown whether the specific game state will occur at the start of the video game. The specific game state may be that a specific change will occur in the progress (flow and development) of the video game, examples of which include the following: (i) an event that has a specific effect on the progress of the video game will occur; and (ii) the game state may have a specific effect on the progress of the video game.

Examples of an “event that has a specific effect on the progress of the video game” include the following: (i) an event that will occur in response to the progress of the video game, which may improve or worsen the game state of the video game; and (ii) an event that will occur based on an input made by the player of the video game, in particular, based on an input to determine a change in the progress of the video game thereafter.

Examples of an “event that will occur based on an input to determine a change in the progress of the video game thereafter” include switching of characters of the video game, specifically, taking the mound by a relief and appearance of a substitute batter.

The “game state that may have a specific effect on the progress of the video game” may be a game state that has more than certain effect on the progress or the outcome (e.g., win or lose) of the video game, which may be that the game state of the video game is improved or is worsened.

The phrase “the game state of the video game is improved” may mean that a runner advances into scoring position during an attack. The phrase “the game state of the video game is worsened” may mean a runner advances into scoring position during a defense.

Examples of a “game state of the video game that has more than a certain effect on the outcome of the video game” include the following :(i) a chance to turn the game (match) around is higher than normal, examples of which include a chance of a one-shot comeback, and a tough situation; (ii) this is the last chance; and (iii) the winner of the game is determined or an extra inning begins (e.g., when a pitcher of the winning team appears in the bottom of the ninth inning). An example of “this is the last chance” may be that the bases are loaded in the bottom of the ninth inning

The specific game state may be that the level of the ability of the specific character of the video game changes, and the changed level is within a preset range. The specific character may be controlled by the player. The ability of the specific character may be an ability that has an effect on winning of the game, examples of which include: (i) an athletic ability of a character controlled by the player, such as power and running power; (ii) an ability of power of concentration of the character; and (iii) intelligence of the character. In one example, a character with high power of concentration may have a high chance of a good outcome when a chance comes, as compared to a character with low power of concentration. Alternatively, the character with low motivation may have a high chance of an error, as compare to a character with high motivation. A character with high intelligence may have a superior understanding of tactics, as compared to a character with low intelligence. The tactics may include a change in a defensive position in response to the batter in the defense.

Examples of the phrase “the level of the ability of the specific character of the video game changes, and the changed level is within a preset range” include the following: (i) the power, the running power, the power of concentration or the motivation of the character is a preset level or less; and (ii) the average of abilities (e.g., powers) of player characters, which join the game and are members of the team controlled by the user, is the preset level or less. In one example, the characters with powers that are average or less may have a high chance of a bad outcome when there is desperation, as compared to characters with powers that are above average.

The specific game state may occur in response to a preset input by the opposing player. The preset input may be made by the player to ask spectators to cheer. In one example, when the preset input is made by the player to ask the spectators to cheer, the number of times the input may be given for one game may be limited.

The specific game state may be one in which the character controlled by the player plays against a specific enemy character. An example of the specific enemy character is a character identified based on a history of the games (matches), which may be a fateful character in the past game. The specific enemy character may be a character identified based on a preset combination of games, an example of which is an opposing character related to a famous game in the real world. If the previous batter is avoided, a pitcher who avoided this batter may be the specific enemy character.

The configuration of each game terminal 10 is not limited to the example shown in FIG. 3. In one example, if the display apparatus 20 shown in FIG. 1 is included in the game terminal 10, the game terminal 10 may include a display 220 that shows various images, such as video game movies.

Next, a hardware configuration of each game terminal 10 will be described with reference to FIG. 4.

FIG. 4 is an example of the hardware configuration of each game terminal 10 shown in FIG. 3.

Each of the game terminal 10 includes a processor 11 (an example of a “processor of a game apparatus”) that controls each part of the game terminal 10, a memory 13 that stores various information, a communication apparatus 15, and an input apparatus 17.

The memory 13 is a non-transitory storage medium, and acts as the memory section 130. The memory 13 includes one or both of volatile memory, such as Random Access Memory (RAM) as a work area of the processor 11, and a non-volatile memory, such as an Electrically Erasable Programmable Read-Only Memory (EEPROM) that stores various information, such as the video game program PRg and the control program PRcg. The memory 13 may be detachable from the game terminal 10, specific examples of which include a storage medium, such as a memory card detachable therefrom. The memory 13 may be an online storage communicatively connected to the game terminal 10 via the network NW or the like. In other words, the “recording medium” having the video game program PRg recorded therein may be a storage included in an external apparatus outside the game terminal 10, or it may be a storage that has the video game program PRg recorded therein and that is included in a distribution server. The distribution server is outside the game terminal 10 and distributes the video game program PRg.

In one example, the processor 11 comprises one or more Central Processing Units (CPUs). In one example, the processor 11 executes the control program PRcg stored in the memory 13 and is operated in accordance with the control program PRcg, to function as the control section 110 that controls each part of the game terminal 10. Furthermore, the processor 11 executes the video game program PRg stored in the memory 13 and is operated in accordance with the video game program PRg, to function as the control section 110 that executes the video baseball game. In one example, the processor 11 that is operated in accordance with the video game program PRg stored in the memory 13 functions as the control section 110 including the game progressor 111, the cheer period setter 112, the cheer information acquirer 113, and the ability setter 114.

In one example of the processor 11 including CPUs, some or all of the functions of the control section 110 may be achieved by operation in cooperation with these CPUs in accordance with a program, such as the control program PRcg and the video game program PRg. In addition to the one or more CPUs, or in place of some or all of the CPUs, the processor 11 may include a Graphics Processing Unit (GPU), a Digital Signal Processor (DSP), a Field Programmable Gate Array (FPGA), or other hardware. A part or all of the control section 110 achieved by the processor 11 may be achieved by hardware, such as a DSP.

The communication apparatus 15 is hardware to communicate with external apparatuses outside the game terminal 10 via one or both of the wired network and the wireless network, and functions as the communication section 150.

The input apparatus 17 is hardware to receive user inputs made to the game terminal 10, and functions as the input section 170. In one example, the input apparatus 17 may comprise one or more devices, including some or all of input buttons, a touch panel, a keyboard, a joystick, and a pointing device, such as a mouse.

Next, a configuration of the distribution server 30 will be described with reference to FIGS. 5 and 6.

FIG. 5 is a functional block diagram showing an example configuration of the distribution server 30 shown in FIG. 1.

The distribution server 30 includes a control section 310 that controls each part of the distribution server 30, a memory section 330 that stores various information, and a communication section 350 that communicates with an external apparatus including the game terminals 10 and the viewer terminal 80-m. The control section 310 includes a movie acquirer 311 that acquires video game information from a game terminal 10 via the communication section 350, and a movie distributor 312 that distributes video game movie MV to a viewer terminal 80-m. In one example, the movie distributor 312 sends video game information to the viewer terminal 80-m via the communication section 350, and distributes the video game movie MV based on the video game information to the viewer terminal 80-m. The memory section 330 stores a control program PRcd for controlling each part of the distribution server 30.

Next, a hardware configuration of the distribution server 30 will be described with reference to FIG. 6.

FIG. 6 is an example of the hardware configuration of the distribution server 30 shown in FIG. 5.

The distribution server 30 includes a processor 31 that controls each part of the distribution server 30, a memory 33 that stores various information, and a communication apparatus 35 that communicates with external apparatuses outside the distribution server 30.

In one example, the memory 33 functions as a memory section 330, and includes one or both of: (i) a volatile memory, such as a RAM, that acts as a work area of the processor 31; and (ii) a non-volatile memory, such as an EEPROM, for storing various information, such as a control program PRcd. In one example, the processor 31 includes one or more CPUs. The processor 31 executes the control program PRcd stored in the memory 33 and is operated in accordance with the control program PRcd, to function as the control section 310. The communication apparatus 35 is hardware to communicate with external apparatuses outside the distribution server 30, and functions as the communication section 350.

The configuration of the distribution server 30 is not limited to the examples shown in FIGS. 5 and 6. In one example, the distribution server 30 may include an input apparatus that functions as an input section that receives inputs by the administrator and others for the distribution server 30.

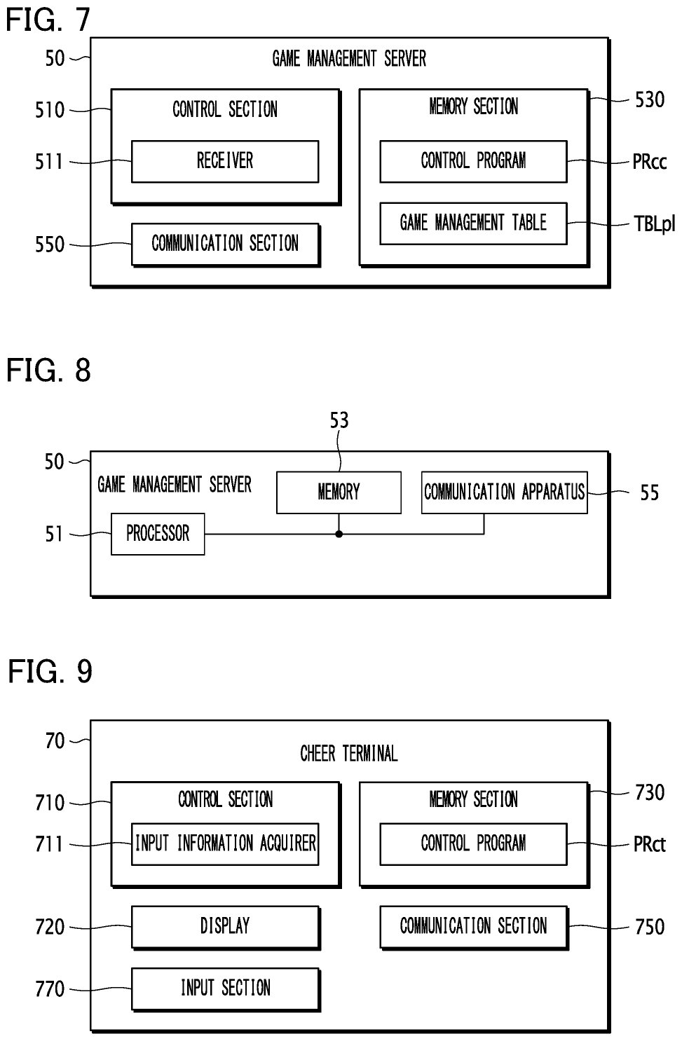

Next, a configuration of the game management server 50 will be described with reference to FIGS. 7 and 8.

FIG. 7 is an example of a functional block diagram of the game management server 50 shown in FIG. 1.

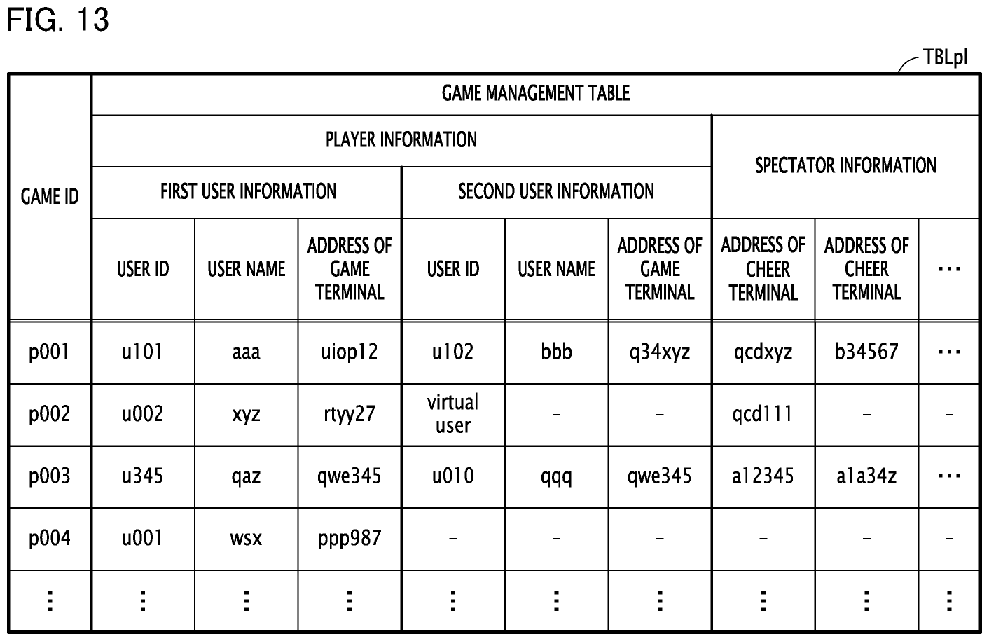

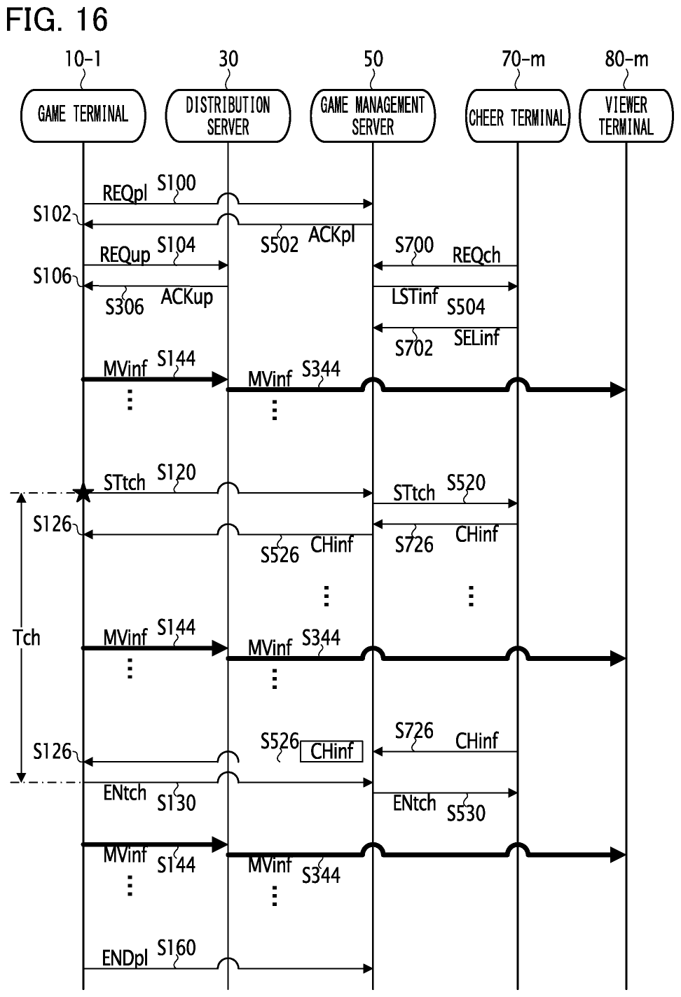

The game management server 50 includes a control section 510 that controls each part of the game management server 50, a memory section 530 that stores various information, and a communication section 550 that communicates with external apparatuses including the game terminal 10 and the cheer terminal 70. The control section 510 includes a receiver 511. The receiver 511 receives cheer information from a cheer terminal 70 via the communication section 550, and sends the received cheer information to a game terminal 10 via the communication section 550. The memory section 530 stores a control program PRcc for controlling each part of the game management server 50, and various information, such as a game management table TBLpl for recording game information related to the baseball video game that is scheduled or is being executed. In one example, the scheduled baseball video game will be executed on the game terminal 10, which has sent an initiation request REQpl shown in FIG. 16 described below to the game management server 50. The data structure of the game management table TBLpl will be described in FIG. 13 below.

Next, a hardware configuration of the game management server 50 will be described with reference to FIG. 8.

FIG. 8 is an example of the hardware configuration of the game management server 50 shown in FIG. 7.

The game management server 50 includes a processor 51 that controls each part of the game management server 50, a memory 53 that stores various information, and a communication apparatus 55 that communicates with external apparatuses outside the game management server 50.

In one example, the memory 53 functions as the memory section 530, and includes one or both of: (i) a volatile memory, such as a RAM, that acts as a work area of the processor 51; and (ii) a non-volatile memory, such as an EEPROM, for storing various information, such as the control program PRcc and the game management table TBLpl. In one example, the processor 51 includes one or more CPUs. The processor 51 executes the control program PRcc stored in the memory 53, and is operated in accordance with the control program PRcc, to function as the control section 510. The communication apparatus 55 is hardware to communicate with external apparatuses outside the game management server 50, and functions as the communication section 550.

The configuration of the game management server 50 is not limited to the examples shown in FIGS. 7 and 8. In one example, the game management server 50 may include an input apparatus that functions as an input section that receives inputs by the administrator and others for the game management server 50.

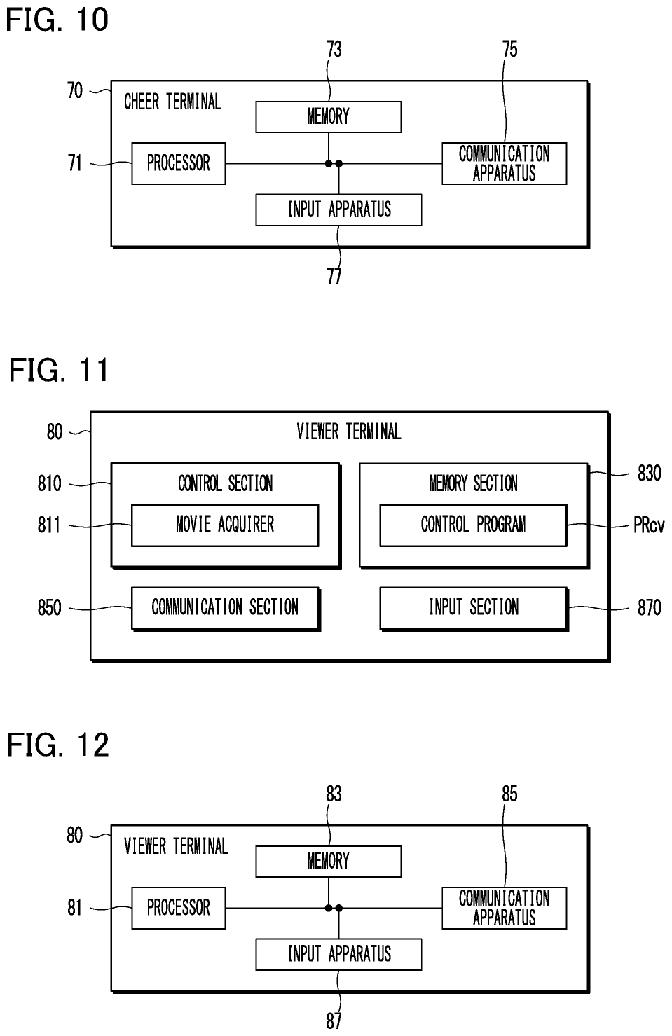

Next, a configuration of each cheer terminal 70 will be described with reference to FIGS. 9 and 10.

FIG. 9 is a functional block diagram showing an example of the configuration of each cheer terminal 70 shown in FIG. 1.

Each cheer terminal 70 includes: a control section 710 that controls each part of the cheer terminal 70; a display 720 that shows various images; a memory section 730 that stores various information; a communication section 750 that communicates with external apparatuses including the game management server 50; and an input section 770 that receives user inputs made to the cheer terminal 70.

The control section 710 includes an input information acquirer 711 that acquires information on content of a user input made to the cheer terminal 70. In one example, in response to a cheering input made to the cheer terminal 70 by the user in a period for cheering, the input information acquirer 711 acquires cheer information based on the cheering input. In other words, in the period for cheering, the input information acquirer 711 receives, via the input section 770, the cheering input made by the user of the cheer terminal 70. In one example, the control section 710 sends via the communication section 750, the cheer information based on the cheering input made to the game management server 50.

If a touch panel is used to achieve the functions of the display 720 and the input section 770, a cheering input may be made by tapping an area or a specific area in the touch panel in the period for cheering. The cheering input may be made by clicking. In this case, a click is made on an area or a specific area within the display screen of the display 720 of the cheer terminal 70 by using a pointing device, such as a mouse, in the period for cheering. The specific area may be an input area assigned to a cheer button for receiving the cheering input.

If the input section 770 has one or more input buttons, the cheering input may be made by pressing a specific input button (e.g., an input button assigned to the cheer button). If a voice input is available on the cheer terminal 70, the cheering input may be made by inputting vocal cheering to the cheer terminal 70. The cheering input may be made by using points for cheering. The points are associated with the user of the cheer terminal 70.

The memory section 730 stores the control program PRct for controlling each part of the cheer terminal 70.

Next, a hardware configuration of each of the cheer terminal 70 will be described with reference to FIG. 10.

FIG. 10 is an example of the hardware configuration of each cheer terminal 70 shown in FIG. 9.

Each cheer terminal 70 includes a processor 71 that controls each part of the cheer terminal 70, a memory 73 that stores various information, a communication apparatus 75 that communicates with external apparatuses outside the cheer terminal 70, and an input apparatus 77 that receives user inputs made to the cheer terminal 70.

In one example, the memory 73 functions as the memory section 730, and includes one or both of: (i) a volatile memory, such as a RAM, that acts as a work area of the processor 71; and (ii) a non-volatile memory, such as an EEPROM, stores various information, such as a control program PRct. In one example, the processor 71 includes one or more CPUs. The processor 71 executes the control program PRct stored in the memory 73, and is operated in accordance with the control program PRct, to function as the control section 710. The communication apparatus 75 is hardware to communicate with external apparatuses outside the cheer terminal 70, and functions as the communication section 750.

The input apparatus 77 functions as an input section 770 that receives user inputs made to the cheer terminal 70. In one example, the input apparatus 77 may comprise one or more devices, including some or all of a touch panel, input buttons, a keyboard, a joystick, and a pointing device, such as a mouse. In this embodiment, an example will be given in which a touch panel (i.e., a touch panel type display) having a display function is used for the input apparatus 77. In such an example, the input apparatus 77 shown in FIG. 10 functions as the input section 770 as well as the display 720 showing various images.

Next, a configuration of the viewer terminal 80 will be described with reference to FIGS. 11 and 12.

FIG. 11 is a functional block diagram showing an example of the configuration of each viewer terminal 80 shown in FIG. 1.

Each viewer terminal 80 includes a control section 810 that controls each part of the viewer terminal 80, a memory section 830 that stores various information, a communication section 850 that communicates with external apparatuses, such as the distribution server 30, and an input section 870 that receives user inputs made to the viewer terminal 80.

The control section 810 includes a movie acquirer 811 that acquires video game information from the distribution server 30 via the communication section 850. The movie acquirer 811 acquires video game information from the distribution server 30 via the communication section 850. The movie acquirer 811 shows, on the display 920, the video game movie MV based on the acquired video game information on the display 920. Here, the display 920 is one included in the display apparatus 90 corresponding to the viewer terminal 80.

The memory section 830 stores a control program PRcv for controlling each part of the viewer terminal 80.

Next, a hardware configuration of the viewer terminal 80 will be described with reference to FIG. 12.

FIG. 12 shows an example of the hardware configuration of each viewer terminal 80 shown in FIG. 11.

Each viewer terminal 80 includes a processor 81 that controls each part of the viewer terminal 80, a memory 83 that stores various information, a communication apparatus 85 that communicates with external apparatuses outside the viewer terminal 80, and an input apparatus 87 that receives user inputs made to the viewer terminal 80.

In one example, the memory 83 functions as a memory section 830, and includes one or both of: (i) a volatile memory, such as a RAM, that acts as a work area of the processor 81; and (ii) a non-volatile memory, such as an EEPROM, stores various information, such as the control program PRcv. In one example, the processor 81 comprises one or more CPUs. The processor 81 executes the control program PRcv stored in the memory 83, and is operated in accordance with the control program PRcv, to function as the control section 810. The communication apparatus 85 is hardware to communicate with external apparatuses outside the viewer terminal 80, and functions as the communication section 850.

The input apparatus 87 is hardware to receive user inputs made to the viewer terminal 80, and functions as the input section 870. In one example, the input apparatus 87 may comprise one or more devices, including some or all of input buttons, a touch panel, a keyboard, a joystick, and a pointing device, such as a mouse.

Next, description will be given of the game management table TBLpl stored in the memory section 530 of the game management server 50 with reference to FIG. 13.

FIG. 13 is an example of a data structure of the game management table TBLpl. In one example, the game management table TBLpl includes records, each of which corresponds to a game (a match) of a baseball video game that is scheduled or is being executed. In the example shown in FIG. 13, the game management table TBLpl includes a plurality of records that correspond one-to-one to a plurality of games of the baseball video game that are scheduled or are being executed. In one example, each record of the game management table TBLpl includes: a game ID to identify the plurality of games that are scheduled or being executed; and game information on the game. In one example, the game information includes player information on users playing a game, and spectator information on users watching the game.

The player information includes first user information on either of two users who play a game (hereinafter, a “first user”), and second user information on the other users (hereinafter, a “second user”). In one example, the first user information includes a user ID to identify the first user, information on a name (a user name) of the first user, and information on an address of a game terminal 10 of the first user. Similarly, the second user information includes a user ID to identify the second user, information on a name (a user name) of the second user, and information on an address of a game terminal 10 of the second user, examples of the address of which include an IP (Internet Protocol) address of the game terminal 10.

In one example, the spectator information includes information on an address of a cheer terminal 70 of a user watching the game, the examples of the address of which include an IP address of the cheer terminal 70.

In the game management table TBLpl shown in FIG. 13, “virtual user” in the user ID included in the second user information represents that the first user plays against a virtual user controlled by the game system 1 or the video game program PRg. The symbol “-” in the user ID of the second user information indicates that the opponent of the first user is unknown at this time. In the record with the game ID “p003”, the same address (“qwe345”) of the game terminal 10 is used for the first and second users. This indicates that the first and the second users control a single game terminal 10, and they play against each other. In this embodiment, main description of the game system 1 is given in which a single game terminal 10 is controlled by a single user. However, a single game terminal 10 may be controlled by multiple users, and these users may play against each other (or cooperate with each other).

The data structure of the game management table TBLpl is not limited to the example shown in FIG. 13. In one example, the spectator information may include a user ID to identify the spectator, and information on a name (a user name) of the spectator. In one example, the game information may include information on a title of a video game movie MV related to the game, or it may be include information on whether to allow users (e.g., spectators) other than the player who executes the game to join the cheer.

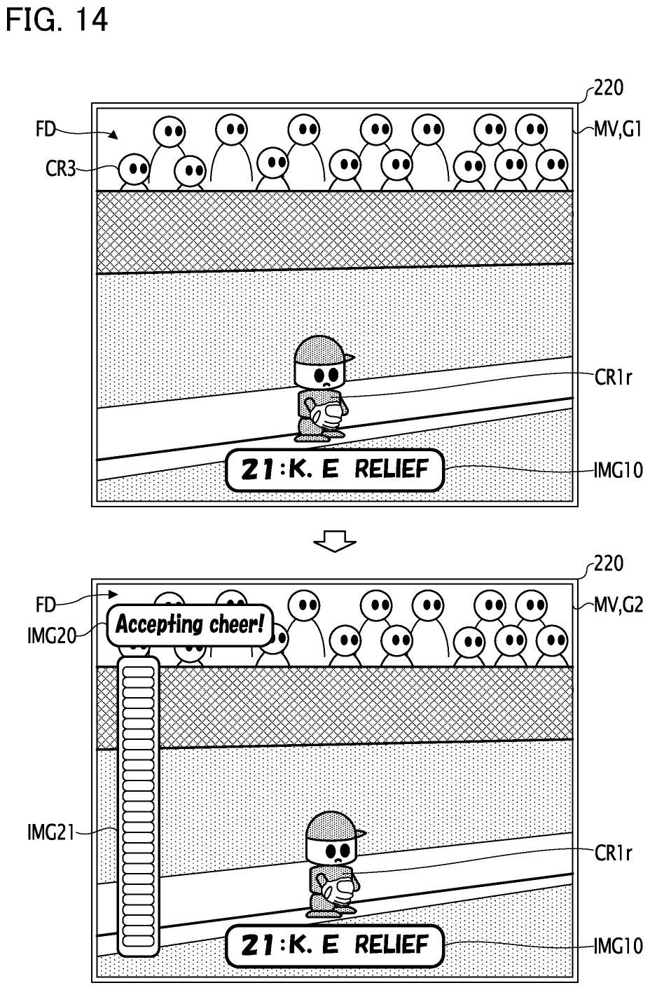

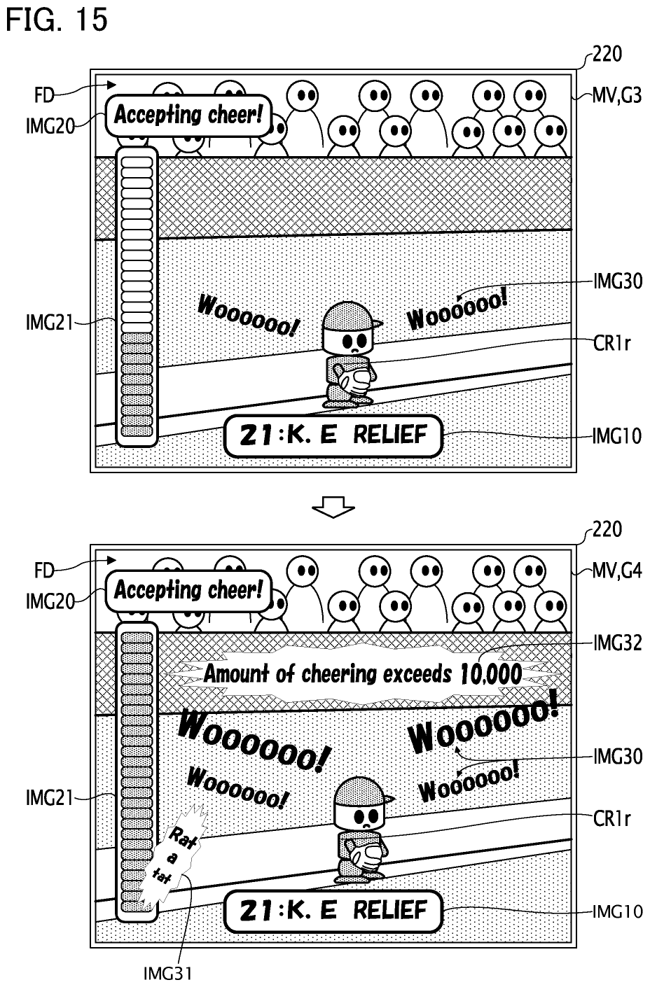

Next, description will be given of an overview of procedures for each game terminal 10 in the period for cheering with reference to FIGS. 14 and 15.

FIG. 14 is a diagram showing an overview of the procedures for each game terminal 10 shown in FIG. 3. In the following description of an overview of procedures for each game terminal 10, an example will be given in which a defense character, such as a pitcher character CR1 that corresponds to a defense player, is controlled by the user of the game terminal 10-1. When the defense character is controlled by the user of the game terminal 10-1, an offense character, such as a batter character CR2 that corresponds to an offense player, is controlled by the user of the game terminal 10-2.

A game image G1 represents a game state of the video game that is progressed based on a user input made to change the pitcher to the game terminal 10-1. In one example, the game progressor 111 progresses the game state of the video game to another game state (an example of a “specific game state”) based on the user input made to change the pitcher to the game terminal 10-1. In the other game state, the relief character CR1r takes the mound. Thereafter, the game progressor 111 shows, on the display 220, the game image G1 representative of the relief character CR1r taking the mound. In one example, the game image G1 shown in FIG. 14 is an image focusing on the relief character CR1r which takes the mound. In the example shown in FIG. 14, the game image G1 includes an image IMG10 representative of information on the relief character CR1r, in addition to images of game elements, such as the relief character CR1r in the virtual space FD.

The cheer period setter 112 initiates a period for cheering to receive cheer for the relief character CR1r (an example of a “specific object”), when the game state of the video game that is progressed based on an user input made to the game terminal 10-1 corresponds to the specific game sate. For this reason, the game progressor 111 updates the game image G1 shown on the display 220 to a game image G2. The game image G2 includes: (i) an image IMG20 representative of the period for cheering (in the example shown in FIG. 14, an image including words “Accepting cheer!”); and (ii) a gauge image IMG21 representative of an amount of cheering based on the cheer information. As a result, the game image G2 including the gauge image IMG21 and others is shown on the display 920 of each viewer terminal 80 of the spectator, who watches the video game movie MV of the baseball video game executed on the game terminals 10-1 and 10-2. Thus, in one example, the spectator who cheers for the baseball team of the user of the game terminal 10-1 is able to participate in cheering for the relief character CR1r by operating the cheer terminal 70.

The spectator who cheers for the baseball team of the user of the game terminal 10-2 does not necessarily participate in cheering for the relief character CR1r. In one example, the period for cheering for a batter character CR2 may start before the relief character CR1r takes the mound. In such an example, by controlling the cheer terminal 70 in the period for cheering for the batter character CR2, the spectator cheering for the baseball team of the user of the game terminal 10-2 is able to participate in cheering therefor. The period for cheering for the batter character CR2 may be ended before the period for cheering for the relief character CR1r starts. In other words, the cheer period setter 112 of the game terminal 10 may set the period for cheering such that the period for cheering for the relief character CR1r does not overlap the period for cheering for the batter character CR2. In such an example, based on the period cheering, the ability setter 114 of the game terminal 10 determines with ease whether the cheer based on the cheer information obtained by the cheer information acquirer 113 is performed for either the relief character CR1r or the batter character CR2.

Next, description will be given of an overview of the procedures for each game terminal 10 in the period for cheering with reference to FIG. 15.

FIG. 15 is a diagram following FIG. 14 which is the overview of the procedures for each game terminal 10.

The game image G3 represents how an amount of cheering for a relief character CR1r is accumulated when each spectator watching the video game movie MV makes a cheering input to the cheer terminal 70. The shaded scale in the gauge image IMG21 represents the total amount of cheering by the spectators in the period for cheering. In other words, the game progressor 111 updates the game image G2 shown on the display 220 to a game image G3. The game image G3 includes the gauge image IMG21 and other images representative of the accumulated amount of cheering for the relief character CR1r. Thus, the game progressor 111 shows, on the display 220, the amount of cheering based on the cheer information in the period for cheering. A game images G3 includes images IMG30 representative of cheering (in the example shown in FIG. 15, each image represents “Woooooo!”).

A game image G4 represents how the amount of cheering for the relief character CR1r increases as time passes since the game image G3 has been shown on the display 220. In the example shown in FIG. 15, the amount of cheering has been accumulated to the upper limit of the scale in the gauge image IMG21, which resulted from cheers by the spectators watching the video game movie MV (which resulted from cheering inputs made to the cheer terminals 70). In the example shown in FIG. 15, for convenience of description, an example will be given in which the amount of cheering is “10,000”, which corresponds to the upper limit of the scale in the gauge image IMG21.

The game image G4 includes: (i) an image IMG32 representative of a certain amount of cheering, when the amount of cheering, which represents the degree of cheering by the spectators, has reached “10,000” (in the example shown in FIG. 15, an image including “Amount of cheering exceeds 10,000”); (ii) an image IMG31 representative of sounds of drums (in the example shown in FIG. 15, an image including “Rat-a-tat”). Furthermore, the images IMG30 have been added to the game image G4. Each of the images IMG30 is larger than each image IMG30 included in the game image G3. The game image G4 represents an increase in cheering, resulting from the images IMG30, IMG31 and other images, as compared to a case in which the game image G3 is shown on the display 220. In other words, the game image G4 represents that the cheers are exciting, as compared to a case in which the game image G3 is shown on the display 220. In one example, the game progressor 111 may direct the performance in response to the cheer information, for example, the spectator characters CR3 in the virtual space FD doing waves, to show that the cheers are exciting.

Thus, the game progressor 111 changes, based on the cheer information, the game image G2 representative of the state of the virtual space FD to the game image G3 or G4 that includes the images IMG 30 representative of cheers. The game progressor 111 may add information on sounds of cheering based on the cheer information to the game video information. The game video information is used to playback the video game movie MV including the game image G4 and the like representative of the state of the virtual space FD. In other words, the game progressor 111 may change one or both of the game image G and sounds representative of the state of the virtual space FD of the game based on the cheer information.

The amount of cheering may change in response to the number of cheering inputs. In such an example, each spectator repeatedly taps the input area assigned to the cheer button within the screen of the display 720 of the cheer terminal 70, to increase the amount of cheering. Since playability to inputs for increasing the amount of cheering maintains is given, each spectator's awareness of participation in a competitive video game. The amount of cheering may increase in response to how many points are consumed by cheering inputs. The points are associated with a spectator of a cheer terminal 70. In such an example, the amount of cheering increases in switching for the points associated with the spectator, as a result of which each spectator's awareness of participation in a competitive video game is maintained. The points may be something that has a value for the baseball video game, or it may be obtained by paying money for the baseball video game.

After a preset time has passed since the start of the period for cheering, the cheer period setter 112 ends the period for cheering. The preset time may be constant regardless of the specific game state, or it may be determined in response to the specific game state. In response to the end of the period for cheering, the ability setter 114 changes the ability associated with the relief character CR1r based on the cheer information obtained by the cheer information acquirer 113 in the period for cheering. It should be noted that the game image G after the period for cheering is not illustrated in FIG. 15. In one example, the ability setter 114 increases the ability related to controlling, a ball speed, etc. associated with the relief character CR1r, in response to the amount of cheering based on the cheer information obtained by the cheer information acquirer 113 in the period for cheering.

Next, an overview of procedures for the game system 1 will be described with reference to FIG. 16.

FIG. 16 is a sequence chart of example procedures for the game system 1 shown in FIG. 1. In FIG. 16, description will be given of procedures for the game system 1 when either one of the game terminals 10-1 and 10-2 supplies the video game movie MV to the distribution server 30. The procedures for the game terminal 10-2 are identical to those of the game terminal 10-1, except that the game terminal 10-1 supplies the video game movie MV to the distribution server 30. For this reason, description of the game terminal 10-2 is omitted in FIG. 16. In addition, for improving readability of FIG. 16, procedures related to the following transmission and reception are omitted. Here, the transmission is sending, by the game terminal 10-1, to the game terminal 10-2, input information on content of inputs made to the game terminal 10-1. The reception is receiving, by the game terminal 10-1, from the game terminal 10-2, input information on content of inputs made to the game terminal 10-2. For improving readability of FIG. 16, the drawing shows a cheer terminal 70-m of the plurality of M cheer terminals 70, and a viewer terminal 80-m of the plurality of M viewer terminals 80. However, the spectator participating in cheering is not limited to the user of the cheer terminal 70-m. A star mark shown in FIG. 16 indicates that the game state of the video game corresponds to the specific game state.

First, the control section 110 of the game terminal 10-1 controls each part of the game terminal 10 such that an initiation request REQpl is sent to the game management server 50 to start a game (a match) of the baseball video game in which spectators participate in cheering (S100).

When the game management server 50 receives an initiation request REQpl, the control section 510 thereof records game information on the game management table TBLpl. The game information is on the baseball video game executed on the game terminal 10-1 that has sent the initiation request REQpl. The control section 510 manages identifiably the baseball video game that is scheduled or being executed. In one example, the control section 510 of the game management server 50 registers the game information on the game management table TBLpl stored in the memory section 530. The game information includes user names and IP addresses of the game terminals 10-1 and 10-2. Thereafter, the control section 510 of the game management server 50 controls each part thereof such that a permission acknowledgement ACKpl to the initiation request REQpl is sent to the game terminal 10-1 (S502).

The control section 110 of the game terminal 10-1 acquires via the communication section 150 the permission acknowledgement ACKpl, which is sent from the game management server 50 as a response to the initiation request REQpl (S102).

The control section 110 of the game terminal 10-1 controls each part thereof such that a distribution request REQup is sent to the distribution server 30 (S104). In one example, the distribution request REQup indicates that the game terminal 10 initiates a supply of the video game movie MV to the distribution server 30.

When the distribution server 30 receives the distribution request REQup, the control section 310 of the distribution server 30 controls each part thereof such that a permission acknowledgement ACKup to the distribution request REQup is sent to the game terminal 10-1 (S306). Thereafter, the control section 110 of the game terminal 10-1 acquires via the communication section 150 the permission acknowledgement ACKup, which is sent from the distribution server 30 as a response to the distribution request REQup (S106).

The control section 710 of the cheer terminal 70-m controls each part thereof such that a cheer participation request REQch is sent to the game management server 50 (S700). In one example, the cheer participation request REQch indicates that the user (the spectator) of the cheer terminal 70-m participates in cheering for the baseball video game. When permitting the user of the cheer terminal 70-m to participate in cheering for the baseball video game, the control section 510 of the game management server 50 controls each part thereof such that game list information LSTinf is sent to the cheer terminal 70-m (S504). The game list information LSTinf represents a list of the baseball video games that is scheduled or being executed, and is generated based on the game information recorded on the game management table TBLpl.

When the cheer terminal 70-m receives the game list information LSTinf, the control section 710 of the cheer terminal 70-m shows, on the display 720, a game list screen based on the game list information LSTinf. Thereafter, the control section 710 of the cheer terminal 70-m controls each part thereof such that game selection information SELinf is sent to the game management server 50 (S702). The game selection information SELinf represents a game that is selected by the user input to be made to the cheer terminal 70-m. The control section 510 of the game management server 50 may include identification information (e.g., the IP address of the cheer terminal 70-m) in the game information corresponding to the game terminal 10-1, to update the game management table TBLpl stored in the memory section 530.

In FIG. 16, an example will be given in which a baseball video game is selected by a user input made to the cheer terminal 70-m to participate in cheering. In the selected baseball video game, the users of the game terminals 10-1 and 10-2 play against each other. Furthermore, in the example shown in FIG. 16, prior to a procedure at step S144 described below, the video game movie MV of the selected baseball video game is viewable to a user of a viewer terminal 80-m. In one example, the phrase “video game movie MV is viewable” may mean that a website is accessed by the viewer terminal 80-m. The website is prepared for playing back the video game movie MV of the baseball video game managed by the game management server 50. Alternatively, it may be that an application program for playing back the video game movie MV of the baseball video game is executed by the viewer terminal 80-m. Thereafter, in one example, the user of the cheer terminal 70-m (i.e., the user of the viewer terminal 80-m) refers to the title, the user name, and etc. of the video game movie MV shown on the display 920-m, to select the video game movie MV corresponding to the selected game at step S702. As a result, the video game movie MV is viewable to the user of the viewer terminal 80-m. When the baseball video game starts at the game terminal 10-1, the video game movie MV is shown on the display 920-m.

In one example, after the game terminal 10-1 receives the permission acknowledgement ACKup, the game terminals 10-1 and 10-2 start the baseball video game. Thereafter, the control section 110 of the game terminal 10-1 controls each of the parts thereof such that the video game movie information MVinf that is used to playback the video game movie MV of the baseball video game is sent to the distribution server 30 (S144).

When the distribution server 30 receives the video game movie information MVinf, the control section 310 of the distribution server 30 controls each part thereof such that the video game movie information MVinf that has been received from the game terminal 10-1 is sent to the viewer terminal 80-m (S344). When the viewer terminal 80-m receives the video game movie information MVinf, the control section 810 thereof shows, on the display 920-m, the video game movie MV based on the video game movie information MVinf received from the distribution server 30.

The game state of the video game is progressed based on a user input made to one or both of the game terminals 10-1 and 10-2. When the game state of the video game corresponds to the specific game state (indicated by a star mark in FIG. 16), the control section 110 of the game terminal 10-1 controls each part thereof such that cheer initiation information STtch on an initiation of a period Tch for cheering is sent to the game management server 50 (S120).

When the game management server 50 receives the cheer initiation information STtch, the control section 510 of the game management server 50 controls each part thereof such that the cheer initiation information STtch is sent to the cheer terminal 70-m (S520). This allows the cheer terminal 70-m to acknowledge that the period Tch for cheering has started. Thereafter, the control section 710 of the cheer terminal 70-m controls each part thereof such that cheer information CHinf is sent to the game management server 50 (S726). The cheer information CHinf is based on a cheering input that is received after the initiation of the period Tch for cheering. Here, the cheer initiation information STtch may be sent from the game management server 50 to other cheer terminals 70 of other spectators, who watch the game in which the users of the game terminals 10-1 and 10-2 play against each other. Similarly, the cheer information CHinf may be sent to the game management server 50 from other cheer terminals 70 of other spectators.

When the game management server 50 receives the cheer information CHinf, the control section 510 of the game management server 50 controls each part thereof such that the cheer information CHinf is sent to the game terminals 10-1 and 10-2 (S526). Thereafter, the control section 110 of the game terminal 10-1 acquires the cheer information CHinf sent from the game management server 50 via the communication section 150 (S126). When the control section 110 of the game terminal 10-1 acquires the cheer information CHinf, the control section 110 shows, on the display 220-1, an amount of cheering based on the cheer information CHinf, as described in FIG. 14.

When a preset time has passed since the initiation of the period Tch for cheering, the control section 110 of the game terminal 10-1 controls each part thereof such that cheer end information ENtch representative of an end of the period Tch for cheering is sent to the game management server 50 (S130).

When the game management server 50 receives the cheer end information ENtch, the control section 510 of the game management server 50 controls each part thereof such that the cheer end information ENtch is sent to the cheer terminal 70-m (S530). This allows the cheer terminal 70-m to acknowledge that the period Tch for cheering has ended. After the end of the period Tch for cheering, the cheer terminal 70-m does not receive any cheering inputs until the next period Tch for cheering starts. The cheer end information ENtch may be sent from the game management server 50 to other cheering terminals 70 of other spectators, who watch the game in which the users of the game terminals 10-1 and 10-2 play against each other.

In response to an end of the period Tch for cheering, the control section 110 of the game terminal 10-1 increases, based on the cheer information CHinf received in the period Tch for cheering, the ability associated with the object to which cheering is given. It should be noted that this is not particularly illustrated. Here, an example will be given in which the object to which cheering is given is a batter character CR2. In such an example, the control section 110 of the game terminal 10-1 increases the ability related to a smash factor, a flight distance of the ball, and the like associated with the batter character CR2, based on the cheer information CHinf received by the cheer information acquirer 113 in the period Tch for cheering.

In response to an end of the game in which users of the game terminals 10-1 and 10-2 play against each other, the control section 110 of the game terminal 10-1 controls each part thereof such that end notification ENDpl representative of an end of the game is sent to the game management server 50 (S160).

The procedures for the game system 1 is not limited to these shown in FIG. 16. In one example, the distribution server 30 and the game management server 50 may manage a plurality of video game movies MV by using movie IDs for identifying these video game movies MV. In such an example, the game management server 50 may send a movie ID to the game terminal 10-1 together with a permission acknowledgement ACKpl. Then, the game terminal 10-1 may send the movie ID received from the game management server 50 to the distribution server 30 together with a distribution request REQup. The game management server 50 may send, as the movie ID, a game ID for identifying a plurality of game to the game terminal 10-1.

In one example, game terminal 10-1 may select whether to include game information in game list information LSTinf that is sent from the game management server 50 to the cheer terminal 70-m. The game information is related to a game in which the users of the game terminals 10-1 and 10-2 play against each other. Specifically, the game terminal 10-1 may send, to the game management server 50 together with an initiation request REQp1, information on whether to include the game information in the game list information LSTinf.

In one example, on the display 920-m is shown (i) a title of the video game movie MV, in which the users of the game terminals 10-1 and 10-2 play against each other, and (ii) a QR code (registered trademark). The QR code is an example of information that is used to send, to the game management server 50, game selection information SELinf representative of participation in cheering for a game. In such an example, the spectator may refer to the list of video game movies MV shown on the display 920-m, and may select a game to participate in cheering. The spectator does not need to refer to the game list screen based on the game list information LSTinf that is sent from the game management server 50 to the cheer terminal 70-m. Accordingly, the above-mentioned steps S700 and S504 may be omitted, if on the display 920-m are shown the QR code as well as the title of the video game movie MV.

In one example, the control section 110 of the game terminal 10-1 may not send, to the game management server 50, the cheer initiation information STtch and the cheer end information ENtch. That is, each cheer terminal 70 does not need to acknowledge the initiation and end of the period Tch for cheering. In one example, if the control section 110 of the game terminal 10-1 does not send the cheer initiation information STtch and the cheer end information ENtch to the game management server 50, the control section 110 may discard cheer information CHinf sent from the game management server 50 outside the period Tch for cheering without receiving it.

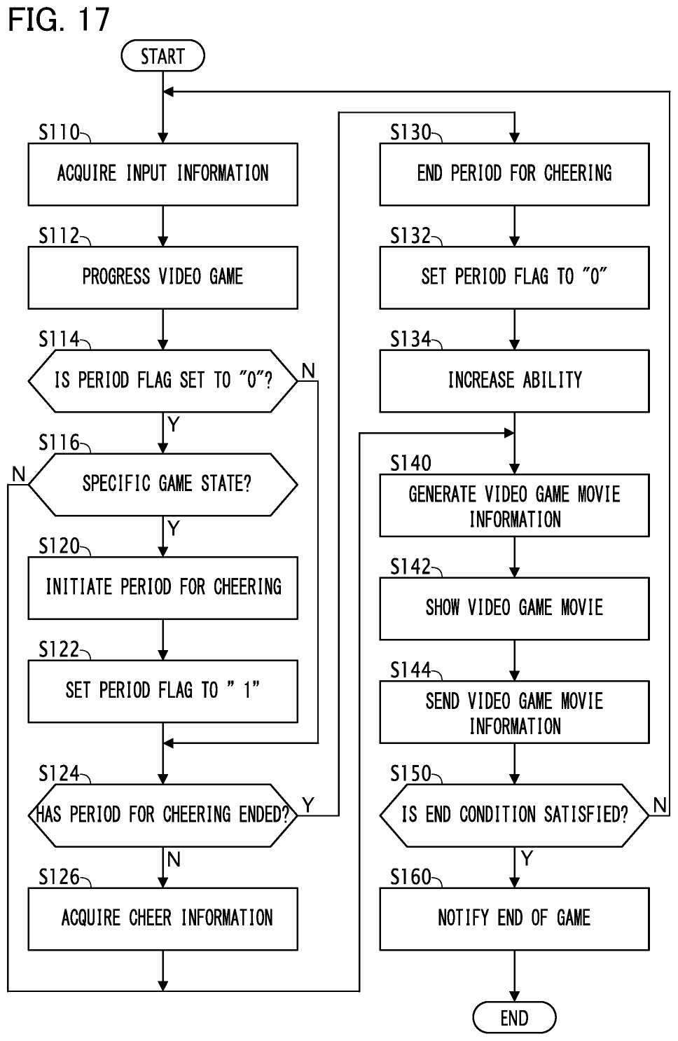

Next, a flow of the game terminal 10 will be described with reference to FIG. 17.

FIG. 17 is a flowchart showing an example of procedures for each game terminal 10 shown in FIG. 3. In FIG. 17, an example will be shown of procedures for each game terminal 10 after the series of steps S100, S102, S104, and S106 shown in FIG. 16 have been executed (sending an initiation request REQpl, acquiring a permission acknowledgement ACKpl, sending a distribution request REQup, and acquiring a permission acknowledgement ACKup). For this reason, step S110 shown in FIG. 17 is executed after the series of steps S100, S102, S104 and S106 shown in FIG. 16 have been executed. In FIG. 17, main description will be given of the game terminal 10-1 when the users of the game terminals 10-1 and 10-2 play against each other. In the description of FIG. 17, unless otherwise noted, the functional blocks, such as the control section 110, are intended to be functional blocks included in the game terminal 10-1.

At step S110, the game progressor 111 acquires input information on content of an input made by the user of each of the game terminals 10-1 and 10-2. In one example, in response to reception of a user input by the input section 170, the game progressor 111 acquires input information on content of the input received by the input section 170. Furthermore, when the communication section 150 receives input information on content of a user input received by the input section 170 of the game terminal 10-2, the game progressor 111 acquires the input information received by the communication section 150. When there is no user input, the game progressor 111 may acquire input information indicating that no user input is received.

Next, at step S112, the game progressor 111 progresses the video game based on the input information acquired at step S110. In other words, the game progressor 111 progresses the video game based on the user input. The game progressor 111 may generate progress state information on a game state of the video game that is progressed based on the input information, at step S112.

Next, at step S114, the cheer period setter 112 determines whether a period flag is set to a value, for example, “0,” which indicates that the period during which the video game is in progress does not correspond to the period Tch for cheering. In one example, the period flag is initialized to “0,” at the start of the baseball video game. When the result of the determination at step S114 is affirmative, the cheer period setter 112 moves the procedure to step S116. Otherwise, the cheer period setter 112 moves the procedure to step S124.

At step S116, the cheer period setter 112 determines whether the game state of the video game that is progressed at step S112 (i.e., the game state of the video game that is progressed based on the user input) is the specific game state. In FIG. 17, description of the specific game state is omitted since it has already been described for FIG. 3. When the result of the determination at step S116 is affirmative, the cheer period setter 112 moves the procedure to step S120. Otherwise, the cheer period setter 112 moves the procedure to step S140.

At step S120, the cheer period setter 112 initiates the period Tch for cheering to receive a cheer for the specific object of the video game. That is, the cheer period setter 112 initiates the period Tch for cheering, when the game state of the video game that is progressed based on the user input made to the game terminal 10 corresponds to the specific game state. The cheer period setter 112 may control the communication section 150 and other parts at step S120 to send, to the game management server 50, cheer initiation information STtch representative of the initiation of the period Tch for cheering.

Next, at step S122, the cheer period setter 112 sets the period flag to a value, for example, “1,” which indicates that the period during which the video game is in progress corresponds to the period Tch for cheering. Thereafter, the cheer period setter 112 moves the procedure to step S124.

At step S124, the cheer period setter 112 determines whether the period Tch for cheering has ended. In one example, when the preset time has passed since the initiation of the period Tch for cheering, the cheer period setter 112 determines that the period Tch for cheering has ended. If the result of the determination at step S124 is affirmative, the cheer period setter 112 moves the procedure to step S130. Otherwise, the cheer period setter 112 moves the procedure to step S126.

At step S126, the cheer information acquirer 113 acquires cheer information CHinf based on the cheering input made by a spectator to a cheer terminal 70. In one example, when cheer information CHinf is received by the communication section 150 from one or more cheer terminals 70 via the game management server 50, the cheer information acquirer 113 acquires the cheer information CHinf received by the communication section 150. Thereafter, the cheer information acquirer 113 moves the procedure to step S140. Thus, in the period Tch for cheering, the cheer information acquirer 113 acquires the cheer information CHinf, and then moves the procedure to step S140. As described above, when it is determined that the period Tch for cheering has ended at step S124, the procedure is moved to step S130.

At step S130, the cheer period setter 112 ends the period Tch for cheering. At step S130, the cheer period setter 112 may control the communication section 150 and other parts, to send the cheer end information ENtch representative of the end of the period Tch for cheering to the game management server 50. Next, at step S132, the cheer period setter 112 sets the period flag to “0.” Thereafter, the cheer period setter 112 moves the procedure to step S134.

At step S134, the ability setter 114 increases the ability associated with the specific object, in response to the total amount of cheering based on the cheer information CHinf acquired by the cheer information acquirer 113 in the period Tch for cheering. An example will be given in which the period Tch for cheering that is ended at step S130 is a period for receiving cheers for the specific character controlled by the user of the game terminal 10-2. In such an example, the procedure at step S134 enables the ability associated with the specific character controlled by the user of the game terminal 10-2 to be increased. After step S134, the ability setter 114 moves the procedure to step S140.

At step S140, the game progressor 111 generates the video game movie information MVinf, which is used to playback the video game movie MV describing the game state of the video game that is progressed at step S112. In one example, the game progressor 111 may generate the video game movie information MVinf, which is used to playback the video game movie MV, based on the progress state information on the game state of the video game that is progressed at step S112.

The video game movie information MVinf generated at step S140 may differ depending on whether the period in which the video game is in progress corresponds to the period Tch for cheering. In one example, at step S140 after step S126 is executed (i.e., step S140 in the period Tch for cheering), the game progressor 111 may include information (e.g., a gauge image IMG21) that is used to show the amount of cheering based on the cheer information CHinf in the video game movie information MVinf. In such an example, the amount of cheering based on the cheer information CHinf is shown on the display 220. The game progressor 111 may not show the amount of cheering based on the cheer information CHinf on the display 220, even when the period during which the video game is in progress corresponds to the period Tch for cheering.

Next, at step S142, the game progressor 111 shows, on the display 220, the video game movie MV based on the video game movie information MVinf generated at step S140. At step S144, the game progressor 111 controls the communication section 150 and other part to send the video game movie information MVinf to the distribution server 30.

Next, at step S150, the game progressor 111 determines whether a given end condition, for example, the end of the baseball video game, is satisfied. When the result of the determination at step S150 is negative, the game progressor 111 returns the procedure to step S110. Otherwise, the game progressor 111 moves the procedure to step S160.

At step S160, the game progressor 111 controls the communication section 150 and other parts, to send an end notification ENDp1 representative of an end of the baseball video game to the game management server 50, and then ends the procedures shown in FIG. 17. In response to receiving the end notification ENDpl, the game management server 50 may delete, from the game management table TBLpl, a record of the game corresponding to the end notification ENDpl.

The procedures for the game terminal 10 is not limited to the example shown in FIG. 17. Some or all of the procedures of steps S114 and S116 may be executed by a functional block different from the cheer period setter 112, for example, the game progressor 111. The progress of step S144 (sending video game movie information MVinf) may be executed before step S142 (showing a video game movie MV), or it may be executed in parallel with step S142.

In one example, at step S122, the cheer period setter 112 may set the period flag to identify whether the period Tch for cheering corresponds to the period to receive a cheers for the team of the user of the game terminal 10-1 or the period to receive a cheer for the team of the user of the game terminal 10-2. When the period Tch for cheering started at step S120 corresponds to the period to receive a cheer for the team of the user of the game terminal 10-1, the period flag may be set to “1” by the cheer period setter 112. When the period Tch for cheering that is started at step S120 corresponds to the period to receive a cheer for the team of the user of the game terminal 10-2, the period flag may be set to “3” by the cheer period setter 112.

In the foregoing embodiment, when the game state of the video game that is progressed by the game progressor 111 based on the user input corresponds to the specific game state, the cheer period setter 112 initiates a period Tch for cheering to receive a cheer for the specific object of the video game. In the period Tch for cheering, the cheer information acquirer 113 acquires, from the cheer terminal 70 communicable with the game terminal 10, cheer information CHinf based on the specific input made to the cheer terminal 70. Thereafter, the ability setter 114 changes the ability associated with the specific object based on the cheer information CHinf acquired by the cheer information acquirer 113 in the period Tch for cheering.

In this embodiment, the period Tch for cheering does not always start at a given timing (e.g., 10 minutes after the video game started). If the period Tch for cheering starts at the preset time, in some cases, the period Tch for cheering is set to a period during which there is a lack of excitement. In such a case, the spectators will not feel an atmosphere of excitement even if they participate in the cheering.

In the foregoing embodiment, the period Tch for cheering starts when the game state of the video game that is progressed based on the user input corresponds to the specific game state. An atmosphere of excitement in a game is an example of a game state in which a specific change in the progress of the video game will occur. Accordingly, in such a case, the spectators are able to participate in cheering in an atmosphere of excitement in the game. As a result, the spectators participating in cheering in the period Tch for cheering are able to feel an atmosphere of excitement.

In this embodiment, who the spectators cheer for is not determined in advance, and therefore the spectators are able to cheer for their favorite players or teams. Thus, in this embodiment, the spectators are able to participate in cheering for their favorite players or teams in an atmosphere of excitement in the game. In this embodiment, the spectators are able to cheer for both teams. In other words, in this embodiment, the spectators are able to participate in cheering in an atmosphere of excitement in the game whenever they wish to participate. As a result, each spectator's awareness of participation in a competitive video game is maintained.

In one example, if the specific state is unknown whether this state will occur at the start of the video game, the spectators are expected to concentrate on the video game since they will try not to miss an opportunity to participate in cheering. In other words, in this embodiment, each spectator's awareness of participation in a competitive video game is maintained.

In one example, if an event that has a specific effect on the progress of the video game will occur, the spectators of the video game are able to participate in cheering in an atmosphere of excitement in the game (e.g., an event of switching of players). As a result, each spectator's awareness of participation in a competitive video game is maintained.

If a game state in which the level of the ability of a specific character of the video game changes, and the changed level is within the preset range, in response to such a change of the level of the ability of the specific character, the period Tch for cheering starts. The game state described above is intended to be a game state in which the ability of the specific character is decreased, and the specific character needs a lot of cheers. Accordingly, in such a game state, the spectators are able to give the specific character a lot of cheers. As a result, each spectator's awareness of participation in a competitive video game is maintained.

In one example, in the period Tch for cheering, the game progressor 111 may show, on the display 220, the amount of cheering based on the cheer information CHinf. In such an example, the amount of cheering based on the cheer information CHinf is shown on the display 220 and the display 920 corresponding to the viewer terminal 80 of the spectator. As a result, the spectators of the video game is able to know that the cheers are exciting. As a result, in this embodiment, each spectator's awareness of participation in a competitive video game is maintained.

In one example, the game progressor 111 may change one or both of the game image G and sound representative of the state of the virtual space FD of the video game in accordance with the cheer information CHinf. In such an example, the video game movie MV reflecting the cheers based on the cheer information CHinf is played back on each display 220 as well as each display 920 of the viewer terminal 80 of the spectator. As a result, the spectators of the video game are able to feel the excitement of cheers. As a result, in this embodiment, each spectator's awareness of participation in a competitive video game is maintained.

In one example, the amount of cheering based on the cheer information CHinf may increase in response to how many points are consumed by cheering inputs. The points are associated with a spectator of a cheer terminal 70. In such an example, since the amount of cheering increases in switching for the points associated with the spectator, each spectator's awareness of participation in a competitive video game is maintained.

### 2. Modifications

The mode described above may be variously modified. Specific modified modes will be exemplified below. Two or more modes freely selected from among the following examples may be appropriately combined in a range so long as they do not conflict. In the modifications exemplified below, elements having operations and functions equivalent to those of the embodiment are also assigned symbols referred to in the above description, and detailed descriptions of the elements are omitted as appropriate.

### Modification 1

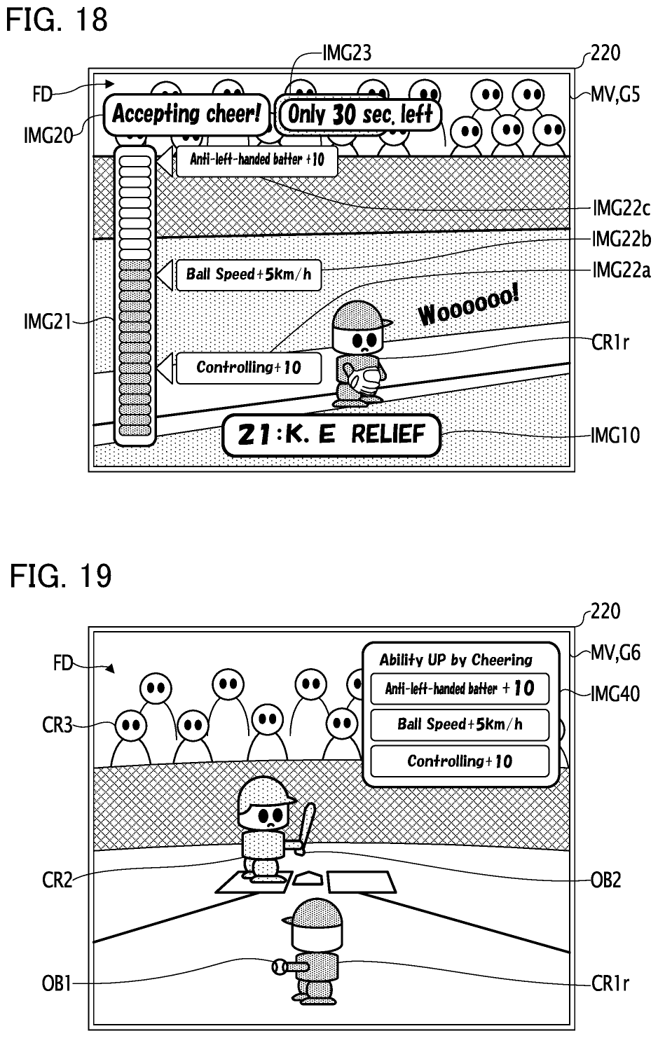

In the foregoing embodiment, description has not been given of way of showing the amount of cheering required to increase an ability associated with a specific object. However, such an amount of cheering may be shown on the display 220, as shown in FIG. 18.

FIG. 18 is a diagram showing an overview of procedures for each game terminal 10 according to modification 1. In FIG. 18, an example will be given in which a specific object is a relief character CR1r. Furthermore, in FIG. 18, the abilities, each of which is associated with the specific object, are a controlling, a speed of the ball, and an anti-left-handed batter, which are associated with the relief character CR1r.

In a game image G5 shown in FIG. 18, on the gauge image IMG21 shown are scales of an amount of cheering, and among the scales, an image IMG22a including words “Controlling +10” is shown at a position of the scale corresponding to the amount of cheering required to increase the controlling. Furthermore, among the scales, an image IMG22b including words “Ball speed +5 km/h” is shown at a position of the scale corresponding to the amount of cheering required to increase the ball speed. Additionally, among the scales, an image IMG22c including words “anti-left-handed batters +10” is shown at a position of the scale corresponding to the amount of cheering required to increase the ability related to anti-left-handed batter.

In this modification 1, in the period Tch for cheering, the game progressor 111 associates the amount of cheering based on cheer information CHinf with the amount of cheering required to increase the abilities, each of which is associated with a specific object, and shows, on the display 220, the amount of cheering based on cheer information CHinf. Accordingly, the spectators are able to know how many the abilities are to be changed due to cheering in the period Tch for cheering.

In the example shown in FIG. 18, the amount of cheering shown in the gauge image IMG21 exceeds both (i) the position indicated by the image IMG22a including “Controlling +10” and (ii) the position indicated by the image IMG22b including “Ball Speed +5 km/h”. For this reason, the controlling and the ball speed of the relief character CR1r have already been determined as increased abilities. However, the amount of cheering shown in the gauge image IMG21 has not yet reached the position indicated by the image IMG22c including the words “Anti-left-handed batters +10.” For this reason, at this moment, the ability of the relief character CR1r related to the anti-left-handed batter is unknown as to whether this ability will increase. When the amount of cheering based on the cheer information CHinf reaches the position indicated by the image IMG22c including “anti-left-handed batters +10” during the remaining of the period Tch for cheering, the ability of the anti-left-handed batters to the relief character CR1r increases. In the example shown in FIG. 18, next to the image IMG20 is shown an image IMG23 including information on the remaining of the period Tch for cheering (e.g., “Only 3 seconds left”).

In this modification 1, the same effects as those in the foregoing embodiment are provided. Furthermore, in this modification 1, the amount of cheering based on the cheer information CHinf is shown on the display 220 in association with the amount of cheering required to increase the abilities. Accordingly, the spectators are able to know how many the abilities to be changed due to cheering in the period Tch for cheering.

### Modification 2

In the foregoing embodiment and modification 1, description has not been given of way of showing effects obtained by the cheer information CHinf in the period Tch for cheering (abilities changed by the cheer information CHinf). However, these effects obtained by the cheer information CHinf may be shown on the display 220 as shown in FIG. 19.

FIG. 19 is a diagram showing an overview of procedures for each game terminal 10 according to modification 2. In FIG. 19, an example will be given in which the specific object is a relief character CR1r. In a game image G6 shown in FIG. 19, in the upper right corner of the screen shown is an image IMG40 representative of the abilities obtained by the cheer information CHinf. In other words, in this modification 2, the game progressor 111 shows the abilities changed by the cheer information CHinf on the display 220, as a result of which the spectators are able to know the abilities changed by cheering. In this modification 2, the same effects as those in the foregoing embodiment and modification 1 are provided.

### Modification 3

In the foregoing embodiments, modifications 1 and 2, description has not been given of a limitation on participation in cheering, but such a limitation may be provided. In one example, a limitation may be provided on the number of periods Tch for cheering to participate in cheering during a period of time from the start to the end of the video game. Alternatively, a limitation may be provided on the total amount of time required for cheering inputs to a cheer terminal 70 (the total amount of time to participate in cheering) during a period of time from the start to the end of the video game. Alternatively, a limitation may be provided on the number of times the cheering inputs may be made to the cheer terminal 70 during a period of time from the start to the end of the video game.

In this modification 3, the same effects as those in the foregoing embodiment and modifications 1 and 2 are provided. Furthermore, in this modification 3, a limitation is provided on the number of cheers per game, as a result of which the game spectators are expected to eagerly watch the video game to participate in cheering at a critical moment.

### Modification 4

In the foregoing modification 3, description has not been given of relationships between the amount of cheering based on the cheer information CHinf and the number of participants cheering in a period Tch for cheering. However, the amount of cheering based on the cheer information CHinf may increase in response to the number of participants cheering in the period Tch for cheering (hereinafter, the number of participants). In one example, in one period Tch for cheering, when the number of participants is less than a preset number (e.g., 100), the amount of cheering may increase by “1” per one cheering input. In addition, when the number of participants is the preset number or more, the amount of cheering increases by “3” per one cheering input. The relationship described above is not limited to such an example (“1” and “3”). The increase in the amount of cheering in response to the number of participants in the period Tch for cheering may be applied to cheering inputs after the number of participants is the preset number or more. Alternatively, it may be applied to all the cheering inputs in the period Tch for cheering going back to the start thereof.

In this modification 4, the same effects as those in the foregoing modification 3 are provided. In addition, in this modification 4, the amount of cheering based on the cheer information CHinf increases in response to the number of participants in the period Tch for cheering. Accordingly, each spectator is able to cheer, given that where other spectators cheer (e.g., when and where is the best for cheering). In other words, in this modification 4, each spectator is able to cheer with an awareness of other spectators.

### Modification 5

In the foregoing embodiment and modifications 1 to 4, description has been given in which a cheer terminal 70 is separate from a viewer terminal 80, but they may be unitary. In one example, a single terminal executes both the application program for cheering (e.g., the control program PRct shown in FIG. 9) and the application program for showing (e.g., the control program PRcv shown in FIG. 11), to achieve functions of the cheer terminal 70 and the viewer terminal 80. In such an example, the single terminal may playback a video game movie MV on the display screen by executing the application program for showing (e.g., a web browser), and may send cheer information CHinf by executing the application program for cheering. The application programs for cheering and showing may be integrated into a single application program.

The application programs for cheering and showing may be integrated into the video game program PRg. In other words, the integrated video game program PRg may include (i) instructions for showing the video game movie MV on a display, and (ii) instructions for receiving cheering inputs, and sending cheer information CHinf in response to the received cheering inputs.

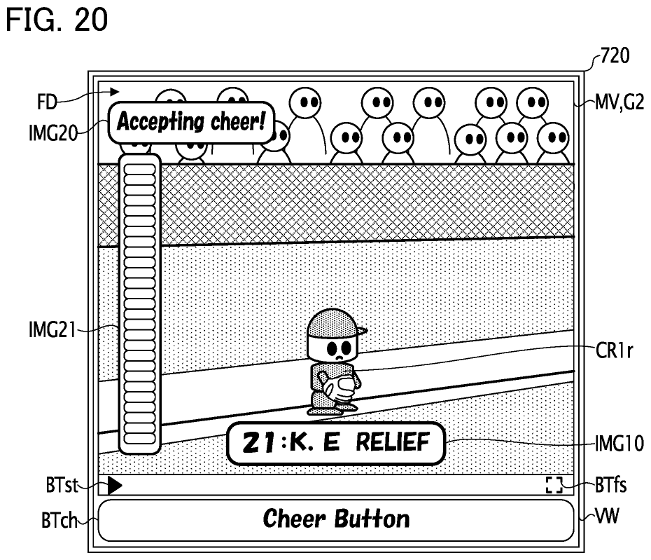

Next, description will be given of an example display image VW shown on a display 720 of a cheer terminal 70 executing the integrated application program with reference to FIG. 20.

FIG. 20 is an example display image VW shown on the display 720 of each cheer terminal 70 according to modification 5. In an example of FIG. 20, the display image VW is obtained by execution of the integrated application. The display image VW includes: a video game movie MV; an input area including a playback button BTst and a full screen button BTfs; and an area of a cheer button BTch assigned to cheering inputs. In one example, the video game movie MV is played back in response to a tapping of the playback button BTst. In response to a tapping of the full screen button BTfs, the video game movie MV is enlarged such that it spreads over the entire display 720. When the video game movie MV is shown over the entire display 720, the cheer button BTch may be shown, it may be hidden by disposing the cheer button BTch in a preset position of the display 720 (e.g., a position of the cheer button BTch shown in FIG. 20).

### Modification 6

In the foregoing embodiment and modifications 1 to 5, a case has been described in which the game system 1 includes the distribution server 30 and the game management server 50, but the present disclosure is not limited to such a case. One or both of the distribution server 30 and the game management server 50 may be omitted from the game system 1. If the distribution server 30 is omitted from the game system 1, each game terminal 10 may distribute video game movie MV to the viewer terminals 80 and similar terminals. If the game management server 50 is omitted from the game system 1, on the display 920 of a corresponding viewer terminal 80 may be show information (e.g., a QR code) on how to send cheer information CHinf to each game terminal 10.

### Modification 7

In the above-mentioned embodiments and modifications 1 to 6, an example of “video game” has been described as a “baseball video game,” but the present disclosure is not limited to such an aspect. A freely selected video game may be used for the “video game.”

The given video game executed by each game terminal 10 may be a soccer video game (another example of a “video game”). If the given video game is a soccer video game, the specific game state may be one in which a penalty kick is given or it may be one in which a free kick in front of the goal is given. The penalty kick and the free kick in front of the goal are examples of an event in which a chance to score a point (hereinafter, a scoring chance) is given. An event in which a scoring chance is given” is an example of an event that improves the game state of the video game. An event in which a scoring chance is given to opposing players is an example of an event that worsens the game state of the video game. An event that improves or worsens a game state of the video game is an example of an event that has a specific effect on the progress of the video game.

In the soccer video game, the specific game state may be that an additional amount of time is added when the player is winning, which is an example of a game to determine whether the match will be won or go into overtime. In the soccer video game, ending the first half does not correspond to the “specific game state may be unknown whether this state will occur at the start of the video game,” which has been described in FIG. 3, because it is already known that this state will occur at the beginning of the game.

The given video game may be a basketball video game (another example of a “video game”). If the given video game is a basketball video game, the specific game state may be one on which free throws are given, which is an example of an event in which a scoring chance is given. The specific game state may be that the scoring chance is given to the opposing players. In the basketball game, ending the first quarter does not correspond to “specific game state may be unknown whether this state will occur at the start of the video game,” which has been described in FIG. 3, because it is already known that this state will occur at the beginning of the game.

The given video game may be a fighting video game (another example of a “video game”). If the given video game is a fighting video game, the specific game state may be one in which a character controlled by the player is taken down, or has fainted. In one example, the character being taken down means that it is more heavily damaged than if it were not. The character having fainted means that it is more heavily damaged than when being taken down. The character controlled by the player being taken down or having fainted is an example of “the game state that has more than a certain effect on the outcome of the video game.”

Furthermore, taking down a character controlled by an opposing player or causing the character to faint is another example of “the game state that has more than a certain effect on the outcome of the video game.”

Here, specific examples will be described of the specific game state in the baseball, soccer, basketball, and fighting video games illustrated in the foregoing embodiment and modification 7.

First of all, in the baseball video game, examples of the specific game state include the following: (i) the next batter appears when a runner advances into scoring position; (ii) a substitute batter appears in a chance of a comeback; and (iii) a pitcher appears in the bottom of the ninth inning when the player is winning; and (iv) a specific batter stands at bat against a specific pitcher (a game against a fateful opponent).

In the soccer video game, examples of the specific game state include the following: (i) a player character is losing its power and moves slower; (ii) switching of player characters; (iii) a penalty kick; and (iv) a free kick in front of the goal. In the basketball video game, examples of the specific game state include the following: (i) a player character is losing its power and moves slower; (ii) switching of player characters; and (iii) a free throw.

In the fighting video game, examples of the specific game state include the following: (i) a player character's power is running out (is about to become the loser); (ii) a player character is likely to take heavier damage, such as fainting or being taken down; and (iii) a player character has taken heavier damage, such as fainting or being taken down.

### Modification 8

In the foregoing embodiment and modifications 1 to 7, an example has been described in which the given video game is executed on the game terminal 10 of the user, but the present disclosure is not limited to such an aspect.

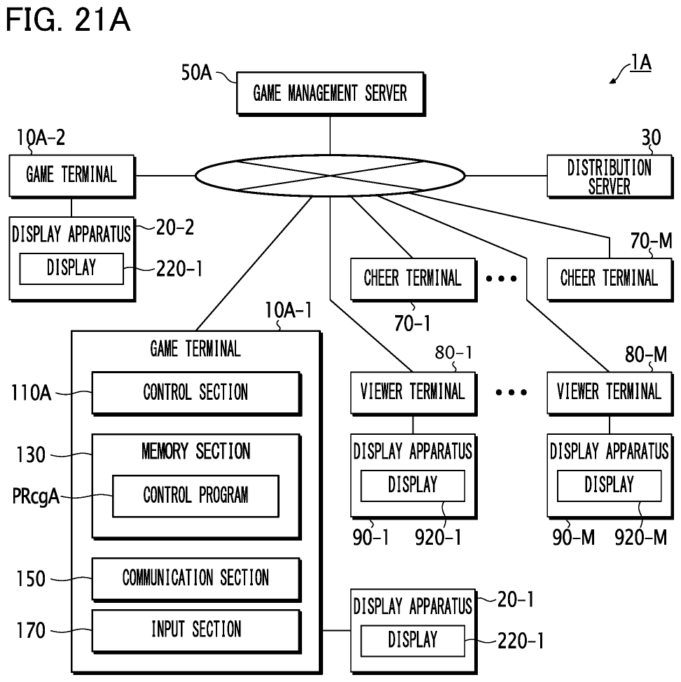

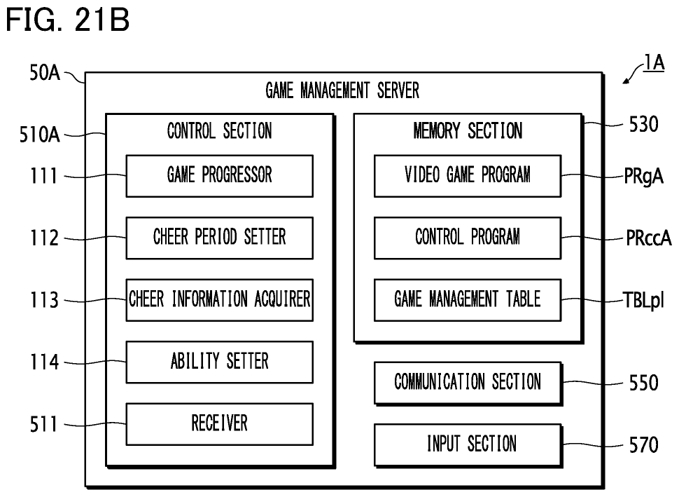

The given video game may be executed on a game management server 50A as shown in FIGS. 21A and 21B.

FIG. 21A is a diagram showing an overview of a game system 1A according to modification 8. FIG. 21B is a functional block diagram showing an example configuration of the game management server shown in FIG. 21A. The game system 1A shown in FIG. 21A includes a game management server 50A instead of the game management server 50 shown in FIG. 1, and a game terminal 10A instead of the game terminal 10 shown in FIG. 1. The game system 1A includes other components identical to those of the game system 1 shown in FIG. 1. In one example, the game system 1A includes the game management server 50A that executes the given video game, a plurality of game terminals 10A (10A-1 and 10A-2), a plurality of display apparatuses 20 (20A-1 and 20A-2), and the distribution server 30. Furthermore, the game system 1A includes a plurality of M cheer terminals 70 (70-1 to 70-M), a plurality of M viewer terminals 80 (80-1 to 80-M), and a plurality of M display apparatuses 90 (90-1 to 90-1) for the respective M viewer terminals 80. The M is a natural number of one or more. Each game terminal 10A, the distribution server 30, the game management server 50A, each cheer terminal 70, and each of the viewer terminals 80 are connected to one another via the network NW to communicate with one another. For improving readability of FIG. 21A, only the functional block of the game terminal 10A-1 from among the game terminals 10A is shown.

The game management server 50A (another example of a “game apparatus”) executes the given video games, and controls communication between the game terminals 10A. Furthermore, the game management server 50A controls communication between the game terminals 10A and the cheer terminals 70. Specifically, as shown in FIG. 21B, the game management server 50A includes: a control section 510A that controls each part thereof; a memory section 530 that stores various information; a communication section 550 that communicates with external apparatuses including the game terminals 10A, the distribution server 30, and the cheer terminals 70; and an input section 570 that receives inputs by an administrator or the like of the game management server 50A. In one example, the memory section 530 stores a video game program PRgA (an example of a “video program”) for executing the given video game, a control program PRccA for controlling each part of the game management server 50A, and the game management table TBLpl.

As described in FIG. 8, the memory 53 functions as the memory section 530. For this reason, in this modification 8, for example, the memory 53, which functions as the memory section 530 that stores the video game program PRgA, corresponds to a non-transitory recording medium having recorded therein the video game program PRgA. In this modification 8, the “storage medium” having recorded therein the video game program PRgA is may be a storage included in an external apparatuses outside the game management server 50A. The external apparatuses may be a distribution server that distributes the video game program PRgA.

In one example, the control section 510A includes the game progressor 111, the cheer period setter 112, the cheer information acquirer 113, and the ability setter 114 as described in FIG. 3. Furthermore, in one example, the control section 510A includes the receiver 511 described in FIG. 7 and other drawings.

As shown in FIG. 21A, the game terminal 10A includes a control section 110A, a memory section 130 that stores the control program PRcgA and other programs of the game terminal 10A, a communication section 150 that communicates with external apparatuses including the distribution server 30 and the game management server 50A, and the input section 170 that receives user inputs made to the game terminal 10A. On the bases of video game information generated by the game management server 50A, the control section 110A shows a video game movie MV of the given video game on the display 220 included in the display apparatus 20 of the game terminal 10A. In this modification 8, the same effects as those of the foregoing embodiment and modifications 1 to 7 are provided.

### 3. Appendices

From the foregoing description, the present disclosure can be understood as follows:

### Appendix 1

A recording medium according one aspect is a non-transitory computer readable recording medium having instructions stored therein that cause at least one processor of a game apparatus to: progress a video game; initiate a period for supporting (e.g., cheering) to receive support for a specific object of the video game, when a game state of the video game that is progressed based on a user input corresponds to a specific game state; acquire support information from a terminal apparatus communicable with the game apparatus in the period for supporting, the support information being based on a specific input made to the terminal apparatus; and change an ability associated with the specific object based on the support information.

According to this aspect, when the game state of the video game corresponds to the specific game state (e.g., in an atmosphere of excitement in a game), the period for supporting to receive support for a specific object starts. For this reason, in this aspect, the user of the terminal apparatus (hereinafter, “a spectator”) is able to participate in supporting for the spectator's favorite team in an atmosphere of excitement in a game. As a result, in this aspect, each spectator's awareness of participation in a competitive video game is maintained.

In the above aspect, the “game state of the video game” may be a game state of a virtual space of the video game, examples of which include a part or all of a game state related to game elements in the virtual space, and a part or all of a game state related to a sound in the virtual space. Alternatively, the “state of the virtual space” may be a part or all of a game state including the following: (i) a game state related to game elements in the virtual space; and (ii) a game state related to a sound in the virtual space.

In the above aspect, in one example, the “specific object” may be controlled by a user playing the game (hereinafter, a “player”).

The “specific object” may be one of characters in the video game, or it may be one of teams in a competitive game in which teams play against each other.

The “support (supporting)” includes two types of support, one of which is cheer, and other of which is financial support, for example, use of points, use of a value for the given video game, and paying money for the game.

In the above aspect, the “specific input” may be an input made by a user of the terminal apparatus by using thereof in the period for supporting. Examples of the “input by using of the terminal apparatus” include: tapping an area or a specific area within the screen of the terminal apparatus; clicking a screen with a pointing device, such as a mouse; pressing a specific input button on a game controller or other operation device connected to the terminal apparatus; inputting vocal support to the terminal apparatus, if a voice input is available on the terminal apparatus; and using points, which are used for supporting and are associated with the spectator.

In the above aspect, the “support information based on a specific input” may represent an amount of supporting obtained by quantifying support by the specific input. The “amount of supporting” may be an index representative of degree of supporting.

In the above aspect, it may be unknown whether the specific game state will occur at the start of the video game. The “specific game state” may be one in which a specific change will occur in the progress (flow and development) of the video game. Examples of the phrase “specific change will occur in the progress of the video game” include the following: (i) an event that has a specific effect on the progress of the video game will occur; and (ii) the game state may have a specific effect on the progress of the video game.

The “event that has a specific effect on the progress of the video game” may an event that will occur based on an input made by the player of the video game.

The “event that will occur based on an input made by the player” may be changing a character of the video game.

The “changing a character” may be switching of players in a competitive team game, such as a baseball or soccer video game, in which teams with players play against each other. Examples of the “switching of players” include taking the mound by a relief, and appearance of a substitute batter, in a baseball video game.

The “event that has a specific effect on the progress of the video game” may be an event that will occur in response to the progress of the video game, which may improve or worsen the game state of the video game.

In a competitive game, in which, the team that scores more points wins, the “event that improves the game state of the video game” may be that a chance to score a point (hereinafter, a scoring chance) is given, examples of which include: (i) in a soccer video game, a penalty kick or a free kick in front of the goal; and (ii) a free throw in a basketball video game.

In a competitive game, in which the team that scores more points wins, the “event that worsens the game state of the video game” may be that a scoring chance is given to an opposing user (hereinafter, opposing player)

The “game state that may have a specific effect on the progress of the game” may be a game state that has more than a certain effect on the progress of the video game, or the outcome of the video game (e.g., win or lose).

The “game state that has more than a certain effect on the progress of the video game” may be that a game state of the video game that is improved or is worsened.

The phrase “the game state of the video game is improved” may be that a runner advances into scoring position during an attack.

The phrase “the game state of the video game is worsened” may be that a runner advances into scoring position during a defense.

In the baseball video game, examples of the “game state of the video game that has more than a certain effect on the outcome of the video game” include the following: (i) a chance of a one-shot comeback or a tough situation; (ii) the bases are loaded in the bottom of the ninth; and (iii) the winner of the game is determined or an extra inning begins.

In the baseball video game, the “game state in which the winner of the game is determined or an extra inning begins” may occur at a timing of an appearance of a pitcher in the bottom of the ninth inning when the player is winning Alternatively, in a soccer video game, it may occur at a timing of an additional amount of time when the player is winning

In a fighting video game, examples of the “game state of the video game that has more than a certain effect on the outcome of the video game” include the following: (i) a character controlled by the player is taken down, or has fainted; and (ii) taking down a character controlled by an opposing player or the character fainting.

The specific game state may be that the level of the ability of the specific character of the video game changes, and the changed level is within a preset range. The “specific character” may be controlled by the player.

Examples of “ability of the specific character include: (i) an athletic ability of a character controlled by the player, such as power and running power; (ii) an ability of power of concentration of the character; and (iii) intelligence of the character.

Examples of the phrase “the level of the ability of the specific character of the video game changes, and the changed level is within a preset range” include the following: (i) power, running power, power of concentration or motivation of the character is a preset level or less; and (ii) the average of abilities (e.g., powers) of player characters is a preset level or less. Here, the player characters join the game and are members of the team controlled by the user.

The specific game state may occur in response to a preset input by the opposing player. The preset input may be made by the player to ask spectators for support.

The “specific game state” may be one in which the character controlled by the player plays against a specific enemy character. An example of a specific enemy character is a character identified based on a history of the games (matches), which may be a fateful character in the past game.

In a sports video game, examples of “specific enemy character” include: (i) an enemy character representative of an opponent based on a famous game in the real world; and (ii) if the previous batter is avoided, a pitcher who avoided this batter.

In the above aspect, examples of “ability associated with the specific object” include an ability defined by a parameter associated with the specific object, and an ability for the specific object to produce an advantageous effect in the video game.

The “ability associated with the specific object” may be an ability of the specific object, or it may be an ability of the game object used by the specific object.

Examples of “ability of the specific object” include the following: (i) an intellectual ability of the specific object; (ii) an ability related to a vitality of the specific object; and (iii) if the specific object is a team, a coordination and tactical understanding of the players on the team.

The “ability of the game object” may be an ability in accordance with use of a game object. Examples of the “ability in accordance with use of a game object” include the following: (i) an ability related to attack, if the game object is an object that is used for attack; (ii) an ability related to defense, if the game object is an object that is used for defense; and (iii) running power or horsepower if, the game object is a moving vehicle, such as a car.

In the above aspect, “changing the ability” may be improving the ability.

### Appendix 2

In the non-transitory computer readable recording medium according to Appendix 1, in the period for supporting, the instructions cause the at least one processor to show, on the display, an amount of supporting based on the support information.

According to this method, the amount of supporting based on the support information is shown on the display, as a result of which the spectator of the video game is able to know that the support is exciting.

### Appendix 3

In the non-transitory computer readable recording medium according to Appendix 2, in the period for supporting, the amount of supporting based on the support information is associated with an amount of supporting required to increase the ability associated with the specific object.

According to this aspect, the amount of supporting based on the support information is shown on the display in association with the amount of supporting required to increase the ability. Accordingly, the spectator of the video game is able to know how many the ability will be changed due to supporting in the period for supporting.

### Appendix 4

In the non-transitory computer readable recording medium according to Appendix 1, the instructions cause the at least one processor to show, on the display, the ability changed by the support information.

According to this aspect, the ability changed by the support information is shown on the display, as the result of which the spectator of the video game is able to know the ability changed by supporting.

### Appendix 5

In the non-transitory computer readable recording medium according to Appendix 1, the instructions cause the at least one processor to change, based on the support information, one or both of: an image representative of a state of a virtual space of the video game, and a sound representative thereof.

According to this aspect, one or both of an image and a sound that reflect the support based on the support information are shown on the display, as the result of which the spectator of the video game is able to feel how the support is exciting.

In the above aspect, the “image representative of the state of the virtual space” may be an image representative of a game element in the virtual space, and it may include an image describing sounds in the virtual space (e.g., vocal support “Ohhhhhh!” “Woooooo!” and drumming sounds “Rat-a-tat”).

The “sounds in the virtual space” is an example of the “sounds representative of the state of the virtual space,” and it may be sounds produced by the game element in the virtual space.

### Appendix 6

In the non-transitory computer readable recording medium according to any one of Appendices 1 to 5, the amount of supporting based on the support information increases in response to how many points are consumed by the specific input, the points being associated with the user of the terminal apparatus.

According to this aspect, for example, the amount of support increases in exchange for points associated with the spectator of the video game, as a result of which less awareness of participation in the video game by the spectator is avoided.

### Appendix 7

In the non-transitory computer readable recording medium according to any one of Appendices 1 to 6, a limitation is provided on participation in supporting by using the specific input in a period of time from a start to an end of the video game.

According to this aspect, a limitation is provided on participation in supporting, as a result of which the spectator of the video game is expected to eagerly watch the video game to participate in supporting at a critical moment.

In the above aspect, examples of “limitation on participation in supporting” include: (i) providing a limitation on the number of periods for supporting in a period of time from a start to an end of the video game; (ii) providing a limitation on the total amount of time to participate in supporting in a period of time from a start to an end of the video game; and (iii) providing a limitation on the number of times of the specific input in a period of time from a start to an end of the video game.

### Appendix 8

In the non-transitory computer readable recording medium according to Appendix 7, in which the instructions cause the at least one processor of the game apparatus to: acquire pieces of support information including the support information from a plurality of terminal apparatuses including the terminal apparatus, each of the plurality of terminal apparatuses being communicably connectable with the game apparatus, each of the pieces of support information being based on the specific input to a corresponding terminal apparatus of the plurality of terminal apparatuses, and change the ability associated with the specific object based on the pieces of support information, in which an amount of supporting based on the pieces of support information increase in response to a number of participants in supporting in the period for supporting.

According to this aspect, the amount of supporting based on the support information increases in response to the number of participants in the period for supporting. Accordingly, each spectator is able to support, given that where other spectators support (e.g., when and where is the best for supporting). In other words, according to this aspect, each spectator is able to support with an awareness of other spectators.

### Appendix 9

In the non-transitory computer readable recording medium according to any one of Appendices 1 to 8, the specific game state is a game state in which an event occurs that has a specific effect on progress of the video game.

According to this aspect, the spectator of the video game is able to participate in supporting in a game state in which an event that has a specific effect on the progress of the video game will occur. The “state in which an event that has a specific effect on the progress of the video game will occur” shows an example of an atmosphere of excitement in a game. Accordingly, according to this aspect, the spectator of the video game is able to participate in supporting, in an atmosphere of excitement in the game.

### Appendix 10

In the non-transitory computer readable recording medium according to any one of Appendices 1 to 8, the specific game state is a game state in which a level of the ability of a specific character of the video game changes, and the changed level is within a preset range.

According to this aspect, the spectator of the video game is able to participate in supporting, in state in which the level of the ability of the specific character of the video game changes, and the changed level is within the preset range. An example will be given in which the level of the ability of the specific character of the video game changes, and the changed level is within the preset range. In such a case, when the ability of the specific character is decreased, and the specific character needs a lot of support, the spectators of the video game are able to participate in supporting to give the specific character a lot of supports.

### Appendix 11

A game apparatus according one aspect includes at least one memory storing a program; and at least one processor that implements the program to: progress a video game; initiate a period for supporting to receive support for a specific object of the video game, when a game state of the video game that is progressed based on a user input corresponds to a specific game state; acquire support information from a terminal apparatus communicably connectable with the game apparatus in the period for supporting, the support information being based on a specific input made to the terminal apparatus; and change an ability associated with the specific object based on the support information.

According to this aspect, the same effects as those in Appendix 1 are provided.

### Appendix 12

A computer-implemented control method for a game apparatus according to one aspect includes: progressing a video game; initiating a period for supporting to receive support for a specific object of the video game, when a game state of the video game that is progressed based on a user input corresponds to a specific game state; acquiring support information from a terminal apparatus communicably connectable with the game apparatus in the period for supporting, the support information being based on a specific input made to the terminal apparatus; and changing an ability associated with the specific object based on the support information.

According to this aspect, the same effects as those in Appendix 1 are provided.

### DESCRIPTION OF REFERENCE SIGNS

1, 1A . . . game system, 10, 10A . . . game terminal, 11 . . . processor, 13 . . . memory, 15 . . . communication apparatus, 17 . . . input apparatus, 20 . . . display apparatus, 30 . . . distribution server, 31 . . . processor, 33 . . . memory, 35 . . . communication apparatus, 50, 50A . . . game management server, 51 . . . processor, 53 . . . memory, 55 . . . communication apparatus, 70 . . . cheering terminal, 71 . . . processor, 73 . . . memory, 75 . . . communication apparatus, 77 . . . input apparatus, 80 . . . viewer terminal, 81 . . . processor, 83 . . . memory, 85 . . . communication apparatus, 87 . . . input apparatus, 90 . . . display apparatus, 110 . . . control section, 112 . . . cheer period setter, 113 . . . cheer information acquirer, 130 . . . memory section, 150 . . . communication section, 170 . . . input section, 220 . . . display, 310 . . . control section, 311 . . . movie acquirer, 312 . . . movie distributor, 330 . . . memory section, 350 . . . communication section, 510 . . . control section, 511 . . . receiver, 530 . . . memory section, 550 . . . communication section, 710 . . . control section, 711 . . . information acquire, 720 . . . display, 730 . . . memory section, 750 . . . communication section, 770 . . . input section, 810 . . . control section, 811 . . . movie acquire, 830 . . . memory section, 850 . . . communication section, 870 . . . input section, 920 . . . display section.

What is claimed is:

1. A non-transitory computer readable recording medium having instructions stored therein that cause at least one processor of a game apparatus to:
progress a video game;
initiate a period for supporting to receive support for a specific object of the video game, when a game state of the video game that is progressed based on a user input corresponds to a specific game state;
acquire support information from a terminal apparatus communicably connectable with the game apparatus in the period for supporting, the support information being based on a specific input made to the terminal apparatus; and
change an ability associated with the specific object based on the support information.

2. The non-transitory computer readable recording medium according to claim 2,
wherein in the period for supporting, the instructions cause the at least one processor to show, on the display, an amount of supporting based on the support information.

3. The non-transitory computer readable recording medium according to claim 2,
wherein in the period for supporting, the amount of supporting based on the support information is associated with an amount of supporting required to increase the ability associated with the specific object.

4. The non-transitory computer readable recording medium according to claim 1,
wherein the instructions cause the at least one processor to show, on the display, the ability changed by the support information.

5. The non-transitory computer readable recording medium according to claim 1,
wherein the instructions cause the at least one processor to change, based on the support information, one or both of:
an image representative of a state of a virtual space of the video game, and
a sound representative thereof.

6. The non-transitory computer readable recording medium according to claim 1,
wherein the amount of supporting based on the support information increases in response to how many points are consumed by the specific input, the points being associated with the user of the terminal apparatus.

7. The non-transitory computer readable recording medium according to claim 1,
wherein a limitation is provided on participation in supporting by using the specific input in a period of time from a start to an end of the video game.

8. The non-transitory computer readable recording medium according to claim 7,
wherein the instructions cause the at least one processor of the game apparatus to:
acquire pieces of support information including the support information from a plurality of terminal apparatuses including the terminal apparatus,
each of the plurality of terminal apparatuses being communicably connectable with the game apparatus,
each of the pieces of support information being based on the specific input to a corresponding terminal apparatus of the plurality of terminal apparatuses, and
change the ability associated with the specific object based on the pieces of support information,
wherein an amount of supporting based on the pieces of support information increase in response to a number of participants in supporting in the period for supporting.

9. The non-transitory computer readable recording medium according to claim 1,
wherein the specific game state is a game state in which an event occurs that has a specific effect on progress of the video game.

10. The non-transitory computer readable recording medium according to claim 1,
wherein the specific game state is a game state in which a level of the ability of a specific character of the video game changes, and the changed level is within a preset range.

11. A game apparatus comprising:
at least one memory storing a program; and
at least one processor that implements the program to:
progress a video game;
initiate a period for supporting to receive support for a specific object of the video game, when a game state of the video game that is progressed based on a user input corresponds to a specific game state;
acquire support information from a terminal apparatus communicably connectable with the game apparatus in the period for supporting, the support information being based on a specific input made to the terminal apparatus; and
change an ability associated with the specific object based on the support information.

12. A computer-implemented control method for a game apparatus comprising:
progressing a video game;
initiating a period for supporting to receive support for a specific object of the video game, when a game state of the video game that is progressed based on a user input corresponds to a specific game state;
acquiring support information from a terminal apparatus communicably connectable with the game apparatus in the period for supporting, the support information being based on a specific input made to the terminal apparatus; and
changing an ability associated with the specific object based on the support information.
